(19) United States
(12) Patent Application Publication
(10) Pub. No.: US 2025/0294515 A1
(43) Pub. Date: Sep. 18, 2025

(54) IDENTITY-FREE LOCATION DETERMINATION OF A DEVICE

(71) Applicant: QUALCOMM Incorporated, San Diego, CA (US)

(72) Inventors: Robert James ANDERSON, Bryn Mawr, PA (US); Joel MORRIN, North Reading, MA (US)

(21) Appl. No.: 18/608,129

(22) Filed: Mar. 18, 2024

(51) Int. Cl. H04W 64/00; H04W 12/02

(52) U.S. Cl. CPC H04W 64/006; H04W 12/02

(57) ABSTRACT

Methods and apparatus for location determination of a device within a wireless network are described. In some embodiments, techniques for such may include generating, by the device, a first identifier corresponding to a first location of the device, the device being associated with a first identifier corresponding to the first location; determining, by the device, a change of location of the device relative to the first location of the device; based on the change of the location of the device exceeding a threshold, generating, by the device, a second identifier associated with the device and corresponding to a second location of the device, the second identifier being distinct from the first identifier; obtaining, by the device, one or more positioning measurements associated with the second location of the device corresponding to the second identifier; and sending, to a network entity, the second identifier and the one or more positioning measurements.

### BACKGROUND

### 1. Field of Disclosure

The present disclosure relates generally to the field of wireless communications, and more specifically to determining the location of a User Equipment (UE) using radio frequency (RF) signals.

### 2. Description of Related Art

Wireless technology such as Wi-Fi (e.g., over a wireless local area networks (WLAN)) or cellular communications can be used to determine and update a device's position based on a collection of wireless signals and measurements. Such an approach to positioning can also rely on crowdsourced information to determine and update positions. For example, beacon-based positioning may involve combining several or many beacon measurements with respect to the device.

### BRIEF SUMMARY

In some aspects of the present disclosure, a method for location determination of a device within a wireless network is disclosed. In some embodiments, the method may include: generating, by the device, a first identifier corresponding to a first location of the device, the device being associated with a first identifier corresponding to the first location; determining, by the device, a change of location of the device relative to the first location of the device; based on the change of the location of the device exceeding a threshold, generating, by the device, a second identifier associated with the device and corresponding to a second location of the device, the second identifier being distinct from the first identifier; obtaining, by the device, one or more positioning measurements associated with the second location of the device corresponding to the second identifier; and sending, to a network entity, the second identifier and the one or more positioning measurements.

In some aspects of the present disclosure, a device is disclosed. In some embodiments, the device may include: one or more transceivers configured for data communication with a network entity; one or more memory; and one or more processors communicatively coupled to the one or more transceivers and the one or more memory, the one or more processors configured to: generate a first identifier corresponding to a first location of the device, the device being associated with a first identifier corresponding to the first location; determine a change of location of the device relative to the first location of the device; based on the change of the location of the device exceeding a threshold, generate a second identifier associated with the device and corresponding to a second location of the device, the second identifier being distinct from the first identifier; obtain one or more positioning measurements associated with the second location of the device corresponding to the second identifier; and send, to a network entity, the second identifier and the one or more positioning measurements.

In some embodiments, the device may include: means for generating a first identifier corresponding to a first location of the device, the device being associated with a first identifier corresponding to the first location; means for determining a change of location of the device relative to the first location of the device; means for, based on the change of the location of the device exceeding a threshold, generating a second identifier associated with the device and corresponding to a second location of the device, the second identifier being distinct from the first identifier; means for obtaining one or more positioning measurements associated with the second location of the device corresponding to the second identifier; and means for sending, to a network entity, the second identifier and the one or more positioning measurements.

In some aspects of the present disclosure, a non-transitory computer-readable apparatus is disclosed. In some embodiments, the non-transitory computer-readable apparatus may include a storage medium, the storage medium including a plurality of instructions configured to, when executed by one or more processors, cause a device to: generate a first identifier corresponding to a first location of the device, the device being associated with a first identifier corresponding to the first location; determine a change of location of the device relative to the first location of the device; based on the change of the location of the device exceeding a threshold, generate a second identifier associated with the device and corresponding to a second location of the device, the second identifier being distinct from the first identifier; obtain one or more positioning measurements associated with the second location of the device corresponding to the second identifier; and send, to a network entity, the second identifier and the one or more positioning measurements.

In some aspects of this present disclosure, another method for location determination of a device within a wireless network is disclosed. In some embodiments, the method may include: determining a change of location of the device relative to a first location of the device, the device being associated with a first identifier corresponding to the first location; based on the change of the location of the device exceeding a threshold, generating a second identifier associated with the device and corresponding to a second location of the device, the second identifier being distinct from the first identifier; obtaining one or more positioning measurements associated with the second location of the device corresponding to the second identifier; and determining a refined location of the device based at least on the one or more positioning measurements associated with the second location of the device and corresponding to the second identifier.

In some aspects of this present disclosure, an apparatus is disclosed. In some embodiments, the computerized apparatus may include: one or more transceivers configured for data communication with a device; one or more memory; and one or more processors communicatively coupled to the one or more transceivers and the one or more memory, the one or more processors configured to: determine a change of location of the device relative to a first location of the device, the device being associated with a first identifier corresponding to the first location; based on the change of the location of the device exceeding a threshold, generate a second identifier associated with the device and corresponding to a second location of the device, the second identifier being distinct from the first identifier; obtain one or more positioning measurements associated with the second location of the device corresponding to the second identifier; and determine a refined location of the device based at least on the one or more positioning measurements associated with the second location of the device and corresponding to the second identifier.

In some embodiments, the apparatus may include: means for determining a change of location of the device relative to a first location of the device, the device being associated with a first identifier corresponding to the first location; means for, based on the change of the location of the device exceeding a threshold, generating a second identifier associated with the device and corresponding to a second location of the device, the second identifier being distinct from the first identifier; means for obtaining one or more positioning measurements associated with the second location of the device corresponding to the second identifier; and means for determining a refined location of the device based at least on the one or more positioning measurements associated with the second location of the device and corresponding to the second identifier.

In some aspects of this present disclosure, another non-transitory computer-readable apparatus is disclosed. In some embodiments, the non-transitory computer-readable apparatus may include a storage medium, the storage medium including a plurality of instructions configured to, when executed by one or more processors, cause an apparatus to: determine a change of location of a device relative to a first location of the device, the device being associated with a first identifier corresponding to the first location; based on the change of the location of the device exceeding a threshold, generate a second identifier associated with the device and corresponding to a second location of the device, the second identifier being distinct from the first identifier; obtain one or more positioning measurements associated with the second location of the device corresponding to the second identifier; and determine a refined location of the device based at least on the one or more positioning measurements associated with the second location of the device and corresponding to the second identifier.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication network.

FIG. 3 is a diagram showing an example of how beamforming may be performed, according to some embodiments.

FIG. 4 is a diagram showing an example beacon-based positioning scenario for a device in a wireless network.

FIG. 5 is a diagram illustrating an example of processing a location request and providing a location response based on a state token.

FIG. 6 is a diagram illustrating an example of processing a location request and providing a location response based on a state token including a state identifier (ID).

FIG. 6A is diagram illustrating an example of processing a location request and providing a location response based on a state token including stationary key information.

FIG. 7 is a diagram illustrating an example of an architecture associated with providing location information to a device.

FIG. 8 is a diagram illustrating example communications between a location server and a device.

FIG. 9 is a flow diagram of an example process for location determination of a device within a wireless network, according to some embodiments.

FIG. 10 is a flow diagram of an example process for location determination of a device within a wireless network, according to some embodiments.

FIGS. 11A and 11B illustrate example scenarios of a device that is considered stationary and not stationary.

FIG. 12 is a flow diagram of another example process for location determination of a device within a wireless network, according to some embodiments.

FIG. 13 is a flow diagram of another example process for location determination of a device within a wireless network, according to some embodiments.

FIG. 14 is a block diagram of an embodiment of a UE, which can be utilized in embodiments as described herein.

FIG. 15 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may absolute location determination, relative location determination, ranging, or a combination thereof. Such positioning may include and/or be based on timing, angular, phase, or power measurements, or a combination thereof (which may include RF sensing measurements) for the purpose of location or sensing services.

Various aspects relate generally to wireless communication and networking, and more particularly to enabling refined positioning of a device. Some aspects more specifically relate to enabling identity-free positioning of a device based on crowdsourced measurements, location records, and other data relating to the position or location of devices. Crowdsourcing approaches may require anonymity of devices. In prior solutions, a set of measurements may be associated with a single location attempt, but this limited the accuracy and benefit of a collection of crowdsourced data. To resolve this limitation, a stateful solution is disclosed herein, in which unique information may be associated with a device. More specifically, a set of positioning measurements with respect to a device may be associated with a piece of unique information herein referred to and explained as a stationary key. A stationary key may correspond to a location of the device but not include identifying information of the device (such as a device identifier (ID)), which maintains the privacy or anonymity of the device within the crowdsourced data. If the device is considered to be in a different location (e.g., based on exceeding a distance threshold or another condition), the device or a network entity such as a location server may generate a new stationary key. The server may then associate measurements taken at the new location with the new stationary key. Even if the device returns to its initial location, the device can be considered a new device at every new change in location with a new stationary key distinct to other stationary keys. Additional ways to obfuscate identification of the device are described herein. Measurements and the associated stationary key may be sent to a network entity (e.g., location server) where crowdsourced data may be stored or accessible. Measurements associated with a given stationary key and location may, without infringing on the privacy of the device or its user, be aggregated, combined, or filtered to produce by the network entity a refined location of the device which is more accurate than a device location based on individual measurements or a set of measurements.

Particular aspects of the subject matter described in this disclosure can be implemented to realize one or more of the following potential advantages. Associating positioning measurements obtained by a device with a unique stationary key that is newly generated depending on a change in state of the device (e.g., device location) keeps a high level of anonymity of the device. Device IDs need not be sent to the network. A network entity may be unable to track the device within the crowdsourced data, since measurements are linked with respective stationary keys but not the device itself. The network entity may calculate a more accurate location of the device and/or of other network devices (such as beacons in the network environment, e.g., access points, base stations, Bluetooth nodes) based on the crowdsourced data but without being able to identify or track the device's location, preserving the anonymity of the device and its owner.

Additional details will follow after an initial description of relevant systems and technologies.

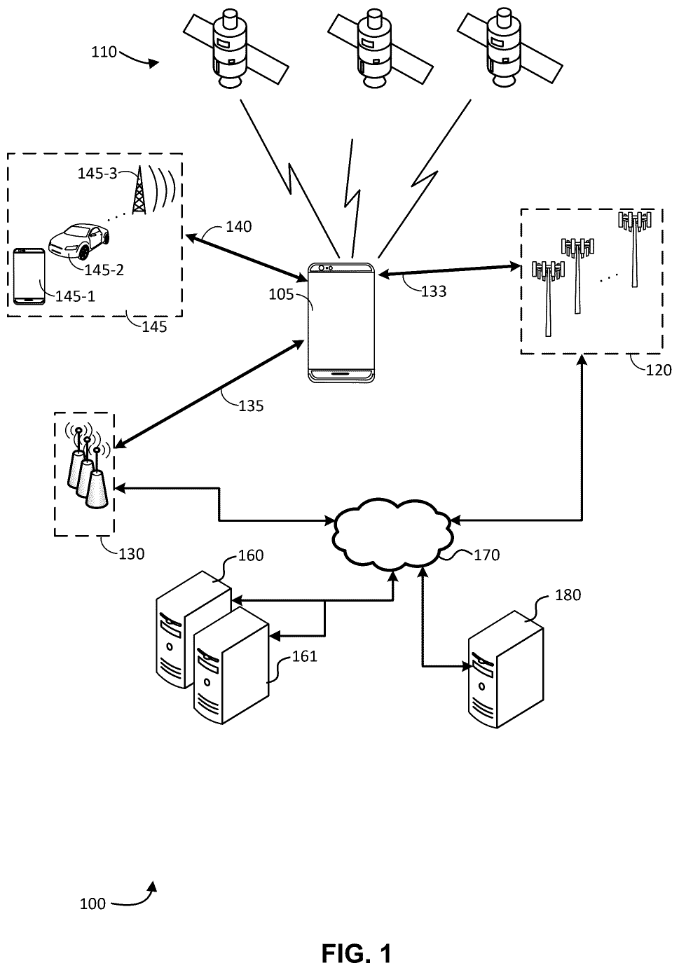

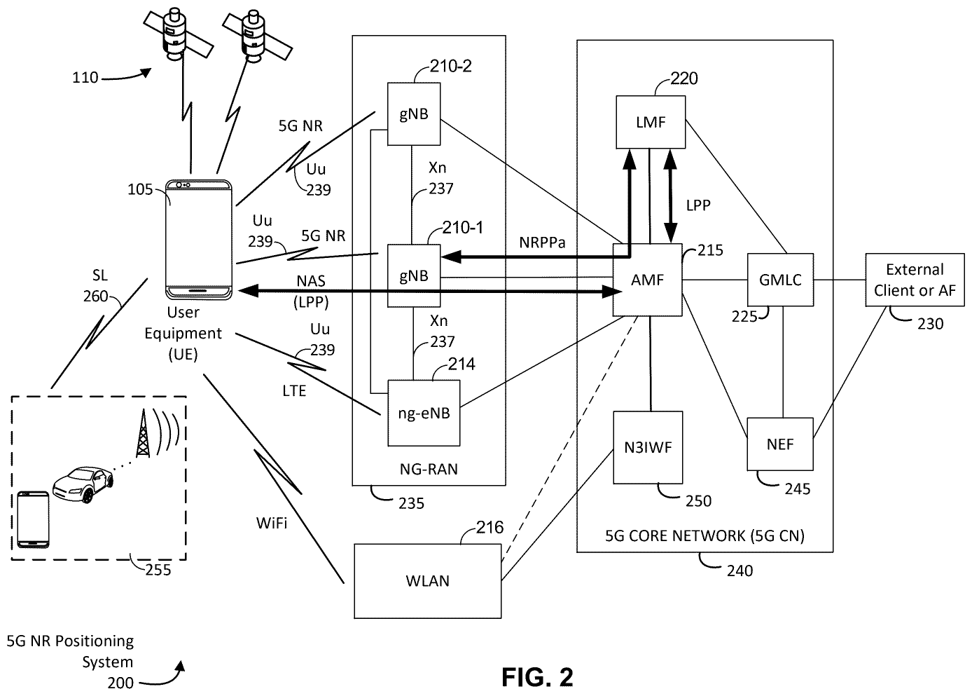

FIG. 1 is a simplified illustration of a positioning system 100 in which a UE 105, location server 160, and/or other components of the positioning system 100 can use the techniques provided herein for, e.g., location determination of UE 105 within a wireless network, according to an embodiment. The techniques described herein may be implemented by one or more components of the positioning system 100. The positioning system 100 can include: a UE 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and/or Non-Terrestrial Network (NTN) satellites; base stations 120; access points (APs) 130; location server 160; crowdsourcing server 161; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

Satellites 110 may be utilized for positioning of the UE 105 in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the UE 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., UE 105) may be facilitated using measurements from one or more anchor devices (e.g., mobile devices 145).

According to some embodiments, such as when the UE 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160 and/or crowdsourcing server 161) to implement the one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network.

The 5G NR positioning system 200 may further utilize information from satellites 110. As previously indicated, satellites 110 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 110 may comprise NTN satellites that may be communicatively coupled with the LMF 220 and may operatively function as a TRP (or TP) in the NG-RAN 235. As such, satellites 110 may be in communication with one or more gNB 210.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of satellites 110, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, or WLAN 216) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220, described in more detail hereafter.

Positioning of the UE 205 in a 5G NR positioning system 200 further may utilize measurements between the UE 205 and one or more other UEs 255 via a sidelink connection SL 260. As shown in FIG. 2, the one or more other UEs 255 may comprise any of a variety of different device types, including mobile phones, vehicles, roadside units (RSUs), other device types, or any combination thereof. One or more position measurement signals sent via SL 260 to the UE 205 from the one or more other UEs 255, to the one or more other UEs 255 from the UE 205, or both. Various signals may be used for position measurement, including sidelink PRS (SL-PRS). In some instances, the position of at least one of the one or more of the other UEs 255 may be determined at the same time (e.g., in the same positioning session) as the position of the UE 205. In some embodiments, the LMF 220 may coordinate the transmission of positioning signals via SL 260 between the UE 205 and the one or more other UEs 255. Additionally or alternatively, the UE 205 and the one or more other UEs 255 may coordinate a positioning session between themselves, without an LMF 220 or even a Uu connection 239 to an access node of the NG-RAN 235. To do so, the UE 205 and the one or more other UEs 255 may communicate messages via the SL 260 using sidelink positioning protocol (SLPP). In some scenarios, the one or more other UEs 255 may have a Uu connection 239 with an access node of the NG-RAN 235 and/or Wi-Fi connection with WLAN 216 when the UE 205 does not. In such instances, the one or more other UEs 255 may operate as relay devices, relaying communications to the network (e.g., LMF 220) from the UE 205. In such instances, a plurality of other UEs 255 may form a chain between the UE 205 and the access node.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAOA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

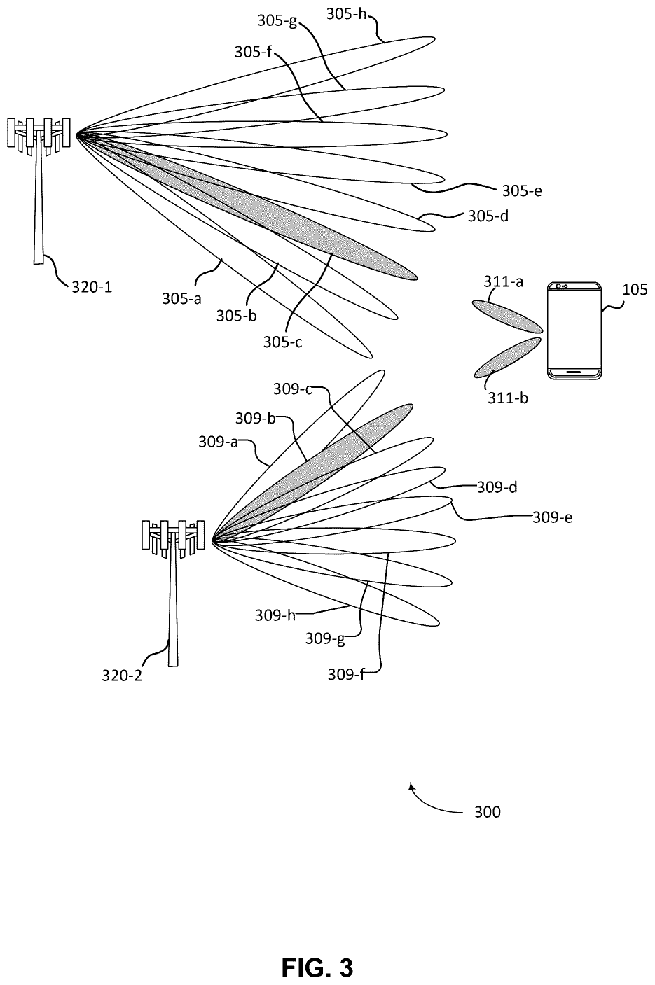

FIG. 3 is a diagram illustrating a simplified environment 300 including two base stations 320-1 and 320-2 (which may correspond to base stations 120 of FIG. 1 and/or gNBs 210 and/or ng-eNB 214 of FIG. 2) with antenna arrays that can perform beamforming to produce directional beams for transmitting and/or receiving RF signals. FIG. 3 also illustrates a UE 105, which may also use beamforming for transmitting and/or receiving RF signals. Such directional beams are used in 5G NR wireless communication networks. Each directional beam may have a beam width centered in a different direction, enabling different beams of a base station 320 to correspond with different areas within a coverage area for the base station 320.

Different modes of operation may enable base stations 320-1 and 320-2 to use a larger or smaller number of beams. For example, in a first mode of operation, a base station 320 may use 16 beams, in which case each beam may have a relatively wide beam width. In a second mode of operation, a base station 320 may use 64 beams, in which case each beam may have a relatively narrow beam width. Depending on the capabilities of a base station 320, the base station may use any number of beams the base station 320 may be capable of forming. The modes of operation and/or number of beams may be defined in relevant wireless standards and may correspond to different directions in either or both azimuth and elevation (e.g., horizontal and vertical directions). Different modes of operation may be used to transmit and/or receive different signal types. Additionally or alternatively, the UE 105 may be capable of using different numbers of beams, which may also correspond to different modes of operation, signal types, etc.

In some situations, a base station 320 may use beam sweeping. Beam sweeping is a process in which the base station 320 may send an RF signal in different directions using different respective beams, often in succession, effectively “sweeping” across a coverage area. For example, a base station 320 may sweep across 120 or 360 degrees in an azimuth direction, for each beam sweep, which may be periodically repeated. Each direction beam can include an RF reference signal (e.g., a PRS resource), where base station 320-1 produces a set of RF reference signals that includes Tx beams 305-a, 305-b, 305-c, 305-d, 305-e, 305-f, 305-g, and 305-h, and the base station 320-2 produces a set of RF reference signals that includes Tx beams 309-a, 309-b, 309-c, 309-d, 309-e, 309-f, 309-g, and 309-h. As noted, because UE 105 may also include an antenna array, it can receive RF reference signals transmitted by base stations 320-1 and 320-2 using beamforming to form respective receive beams (Rx beams) 311-a and 311-b. Beamforming in this manner (by base stations 320 and optionally by UEs 105) can be used to make communications more efficient. They can also be used for other purposes, including taking measurements for position determination (e.g., AoD and AoA measurements).

As discussed herein, in some embodiments, TDOA assistance data may be provided to a UE 105 by a location server (e.g., location server 160) for a “reference cell” (which also may be called “reference resource”), and one or more “neighbor cells” or “neighboring cells” (which also may be called a “target cell” or “target resource”), relative to the reference cell. For example, the assistance data may provide the center channel frequency of each cell, various PRS configuration parameters (e.g., N_{PRS}, T_{PRS}, muting sequence, frequency hopping sequence, PRS ID, PRS bandwidth), a cell global ID, PRS signal characteristics associated with a directional PRS, and/or other cell related parameters applicable to TDOA or some other position method. PRS-based positioning by a UE 105 may be facilitated by indicating the serving cell for the UE 105 in the TDOA assistance data (e.g., with the reference cell indicated as being the serving cell).

In some embodiments, TDOA assistance data may also include “expected Reference Signal Time Difference (RSTD)” parameters, which provide the UE 105 with information about the RSTD values the UE 105 is expected to measure at its current location between the reference cell and each neighbor cell, together with an uncertainty of the expected RSTD parameter. The expected RSTD, together with the associated uncertainty, may define a search window for the UE 105 within which the UE 105 is expected to measure the RSTD value. TDOA assistance information may also include PRS configuration information parameters, which allow a UE 105 to determine when a PRS positioning occasion occurs on signals received from various neighbor cells relative to PRS positioning occasions for the reference cell, and to determine the PRS sequence transmitted from various cells in order to measure a signal ToA or RSTD.

Using the RSTD measurements, the known absolute or relative transmission timing of each cell, and the known position(s) of wireless node physical transmitting antennas for the reference and neighboring cells, the UE position may be calculated (e.g., by the UE 105 or by the location server 160). More particularly, the RSTD for a neighbor cell “k” relative to a reference cell “Ref,” may be given as (ToAₖ-ToA_{Ref}), where the ToA values may be measured modulo one subframe duration (1 ms) to remove the effects of measuring different subframes at different times. ToA measurements for different cells may then be converted to RSTD measurements and sent to the location server 160 by the UE 105. Using (i) the RSTD measurements, (ii) the known absolute or relative transmission timing of each cell, (iii) the known position(s) of physical transmitting antennas for the reference and neighboring cells, and/or (iv) directional PRS characteristics such as a direction of transmission, the UE 105 position may be determined.

The foregoing describes some techniques to obtain signal measurements for position determination of a UE. To recapitulate, some examples discussed include signal timing measurements (e.g., RTT, TDOA, TOA, Rx-Tx), signal angle measurements (e.g., AoA, AoD, beamforming), signal strength, power, or quality measurements (e.g., RSSI, RSRP, RSRQ), WLAN (e.g., Wi-Fi) positioning, beacon-based measurements, and D2D measurements (e.g., sidelink-assisted measurements, e.g., where one or more other UEs are anchors). Position procedures implementable according to the present disclosure are not limited to such and may be performed with others with similar effect within various types of wireless networks including WLAN- and/or 3GPP-based networks.

Generally, beacon-based positioning may be used with various known devices within the network infrastructure. As alluded to above, beacons may refer to wireless-enabled network devices. A base station may be an example of a beacon, which may transmit signals such as reference signals or broadcast information such as assistance data. In some cases, a beacon may be a positioning-only node that may send signals but may not, e.g., relay information between devices (e.g., the positioning-only beacon may not receive signals from a UE, or transmit signals to a server, or both). In some cases, a beacon may be a detecting-only node that may not send signals or data but may scan for signals and transmit signal or related information to other network entities. A node configured to use a Bluetooth protocol (including BLE) may be another example of a beacon. A Wi-Fi AP may be another example of a beacon. In some scenarios, beacons may enable a device such as a UE to obtain one or more of the above types of measurements.

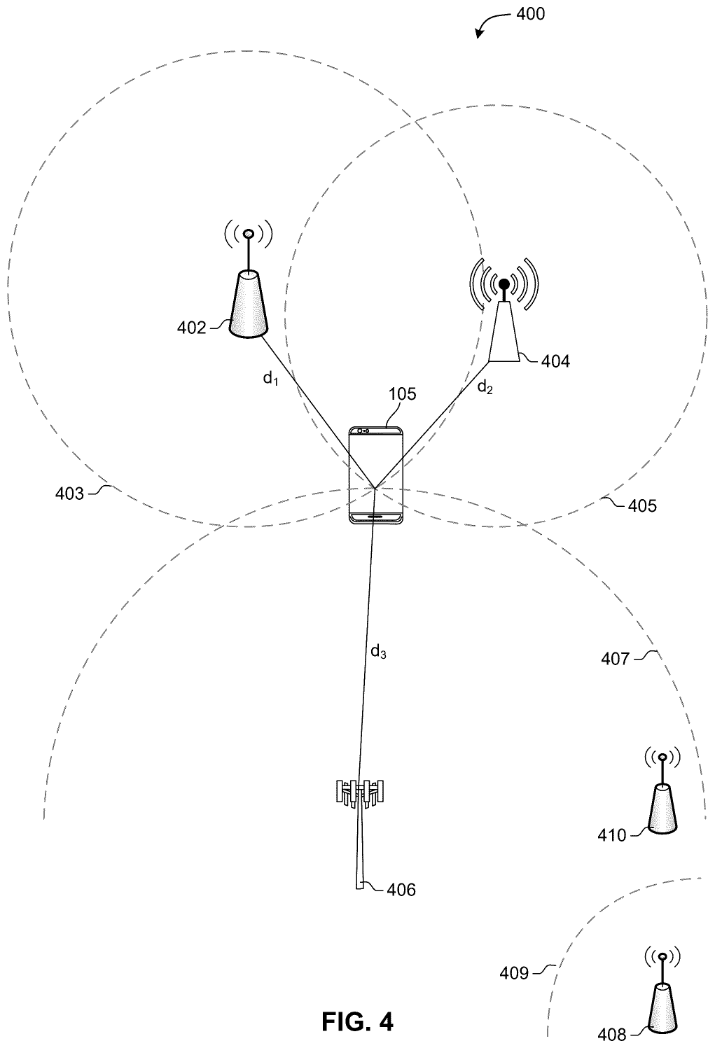

FIG. 4 is a diagram showing an example beacon-based positioning scenario 400 for a device in a wireless network. Beacon-based positioning may be performed in an outdoor environment or an indoor environment to determine a location of the device (e.g., UE 105). At least a first beacon 402, a second beacon 404, and a third beacon 406 may be known within the environment. A Wi-Fi AP may be an example of the first beacon 402. A Bluetooth-enabled node may be an example of the second beacon 404. A base station may be an example of the third beacon 406. Depending on application and requirements (e.g., indoor/outdoor, power, infrastructure, cost, device or type of device to be positioned), different type(s) of beacons may be used, each having different levels of signal range and coverage. It will be appreciated that there may be more (or fewer) than three beacons, and any of the various types of beacons may be used or substituted for any of the beacons, including but not limited to the network devices discussed herein. For instance, all of the beacons may be Wi-Fi APs or base stations.

In the illustrated example, the first beacon 402 may have a signal range 403 of at least d1. The second beacon 404 may have a signal range 405 of at least d2. The second beacon 406 may have a signal range 407 of at least d3. The position of each of the three beacons 402, 404, 406 may be known to the network (e.g., a location server 160). In addition, d1, d2 and d3, which are the distances between the beacons and the UE 105, may be determinable (or known). In some examples, the distances d1, d2 and d3 may be derived from signal strength measurements taken by the UE 105 such as RSSI with respect to each beacon, since the relationship of RSSI and distance is that distance increases as RSSI decreases.

Hence, given the locations of each beacon 402, 404, 406 and the distances to beacons acting as reference points (d1, d2 and d3), a position of the UE 105, where the centroid of the signal ranges of the beacons is, may be triangulated (e.g., by a location server, or other network device such as a node aware of beacon locations and measurements), or otherwise derived based on three sets of equations to find the third variable of the UE's position.

In some scenarios, at least a fourth beacon 408 may be part of the wireless network. However, its signal range 409 may not reach the UE 105 and/or be relevant to the positioning of UE 105. In some scenarios, at least a fifth beacon 410 may be part of the wireless network. The fifth beacon 410 may have a signal range (not shown) that can reach the UE 105. However, the UE 105 may or may not use the fifth beacon 410 depending on factors such as network conditions or signal quality. Since the distance between a beacon the UE 105 should be accurate to determine the correct position, if RSSI is irregularly measured or affected by the environment or network condition, then the UE 105 may deem the fifth beacon 410 unreliable or to be lower priority for beacon-based positioning.

As can be seen, various techniques for positioning can be performed by the UE 105 and/or a network entity (e.g., a server). Complex, advanced applications such as crowdsourcing from multiple devices require combining many positioning measurements and estimations by many devices (which may be stored at a location server or other device(s) of the network) over time to create position information for each beacon in a database, which can enhance and refine the positioning accuracy and reliability for positioning a given device. As examples, hundreds, thousands, millions, hundreds of millions, etc. devices and positioning measurements may be stored and added to the database. Taking beacon-based positioning scenario 400 as an example, the accuracy of crowdsourced data and ultimately the accuracy of the location solution depends upon the accuracy of the device location associated with beacon measurements, as well as the accuracy of the individual beacon measurements.

However, privacy issues can arise from collecting a large amount of data from a large number of devices in the network. Namely, anonymity of the devices or their users may be compromised. In some situations, identifying information of the device (e.g., device identifier (ID)) may be attached to measurements sent to the network (e.g., a location server). Even in situations where identifying information is not attached to information sent to the network, a set of distinct locations known to be associated with the same device can make it possible to identify the device without an explicit device ID collected from a device. Collecting these crowdsourced measurements cannot be linked with a device ID where privacy requirements are enforced. Identifying the device within a collection of crowdsourced measurements may infringe privacy requirements. Where privacy or anonymity is required, it must not be possible to follow or track a device within the crowdsourced data or derive the identity of the device from the crowdsourced data. In attempts to resolve such a requirement, a set of measurements may be associated with a single location attempt, but this limits the accuracy and benefit of a collection of crowdsourced data.

To these ends, unique information such as a “state token” may be used to enhance the privacy and anonymity of devices so as to make discernment of a device's identity more difficult.

As used herein, the term “state token” may refer to a token that includes stateful components of the algorithms used to produce, filter, smooth, debounce, or otherwise adjust a determined location associated with a device. The stateful components may be one or more elements that may include one or more of a last (which may also be referred to as “most recent”) location associated with the device, a last serving cell associated with the device, confidence metrics and uncertainties associated with a calculated device location (or associated with the most recent location), the calculated device location, a last location provided by the location server, one or more accumulated measurement of beacon signals that includes one or more previous geo-spatial positioning results, one or more positions determined based on a positioning mechanism (e.g., and associated confidence metrics or uncertainties), a state ID, a weight associated with samples, calculated device locations, the one or more positions, or the like. In some aspects, a state token may not include an identifier that allows the location server to determine multiple location requests or state tokens to be associated with a same device. In some embodiments, unique information or a unique key (e.g., string value with alphanumeric and/or other type of characters) associated with the device may be included in a state token as a stateful component, while not including an identifier of the device. In some implementations, such a unique key may be randomly or pseudorandomly generated, based on one or more measurements made or otherwise obtained by the device, and/or based on one or more properties associated with the device (e.g., motion or lack of sufficient motion, change in location or lack thereof, direction, pose, type of device, capabilities), network (including devices of the network), region, environment, other devices, and/or other elements (e.g., time of day, week, month, year, etc.). Such unique information associated with the device may be dependent on a state or characteristic of the device, or on the one or more measurements or properties listed above, and the unique information may be changed along with or depending on the state or characteristic of the device or on the one or more measurements or properties listed above (e.g., with respect to a threshold) or other on other conditions (e.g., time elapsed since having the unique information or taking a measurement, time of day, condition of network or environment, number of devices). In other words, a state token may not include a persistent (e.g., an identifier that can be unchanged after a location request) identifier associated with the device (even if the persistent identifier is generated by a network or a server), such as an international mobile equipment identity (IMEI), permanent equipment identifier (PEI), international mobile subscriber identity (IMSI), a permanent identifier associated with the device, a temporary identifier associated with the device generated for a purpose other than the location request (e.g., an identifier generated by a network entity associated with the core network or the serving cell to facilitate wireless communication), a radio network temporary identifier (RNTI), a temporary mobile subscriber identity (TMS), a globally unique temporary identity (GUTI), or the like. In some aspects, a state token may include a state ID uniquely associated with the state token. In some aspects, the state ID may be generated based on the one or more other elements in the state token. A state ID may be a randomly generated single-use value that served as a key into stateful data, which may also be referred to as “state data.” State data may represent or indicate a state(s) of a device (e.g., UE), its user, an associated or coupled component (e.g., a vehicle), or even other devices or entities of a network or system associated with the device, user, or associated component. In some scenarios, the state data may be based on the mobility type, e.g., stationary, sitting, standing, lying down, walking, running, driving, biking, swimming, flying, etc. In some implementations, mobility type may be determined based on data from one or more inertial sensors (including, e.g., a gyroscope and/or an accelerometer), velocity data, time of day, and/or other types of sensors (such as sensor(s) 1440) or type of information. In some scenarios, the state data may be based on the device type. In some scenarios, the state data may be based on a combination of the above. For example, an automated gathering vehicle (e.g., harvesting machine or robotic vehicle or apparatus) that is stationary, one that is moving a robotic arm coupled to the vehicle, and one that is moving to a new location may all have different state data or state IDs. In these examples, a robotic arm may have different states for moving along a two-dimensional horizontal plane (x- and y-axes) and for moving along a third axis (vertical z-axis). That is, there may be differentiation in state data or state ID between two-dimensional and three-dimensional movement (e.g., moving along the z-axis or not) or position (e.g., sitting versus standing at different height). There may also be differentiation in state data or state ID between one-dimensional and two-dimensional movement (e.g., moving within a plane or along a line only) or position (e.g., seated or standing at a fixed position such as a chair, in front of a door or not, blocking a line of sight or not). Furthermore, in some implementations, state data may vary based on where crowdsourced data from multiple devices or users in the network is being reported, or based on what information is being reported. As an example, crowdsourced measurement data from devices may be associated with state data that is different from, for instance, location data of the devices. That is, state data may be different depending on whether a device is sending measurement data or location data. As a further example, a device sending measurement data at a first location may have different state data than a device sending measurement data at a second location, even though it may not be known to a receiving entity (e.g., a server) that the location of the device is different. Furthermore, in some implementations, state data may vary based on positioning method used. For example, different devices may transmit different types of measurement data (e.g., UWB and vision data). Different state data or state IDs may be associated for those devices based on the positioning method. The state ID may be encoded and may be used by a location server or a device (or another device associated with the device). A new state ID may be generated for every location request and an old state ID may be configured to be discarded after each use (e.g., discarded by the location server after transmitting a response or deleted by the device upon receiving a new state ID associated with a new state token). A state ID does not allow the location server to associate multiple location requests to a single device due to the state ID changes for every location request. By using a state ID, a location server may temporarily store the state token in the event that a device become offline after transmitting a location request, and the location server may transmit a location response after the device come online. In some aspects, an initial location request (a first-in-time location request during a time period that may be configured by the location server) transmitted from the device to the location server may be based on a null state token. A state token may be referred to as a null state token if it does not include information regarding: a most recent location associated with the device, a most recent serving cell associated with the device, an observation variance associated with the device, a location history associated with the device, one or more uncertainties associated with a calculated location, one or more confidence metrics associated with the calculated location, historical location related measurements associated with the device, unique information associated with the device, and one or more state machine values associated with the device. In some aspects, a state token included in a most recently received location response may be included in a subsequent location request from the device to the location server. In some aspects, a state token that is not a null state token may be constructed by the location server but not by the device itself or another device different from the location server. A null state token may be constructed by the device itself or another device different from the location server.

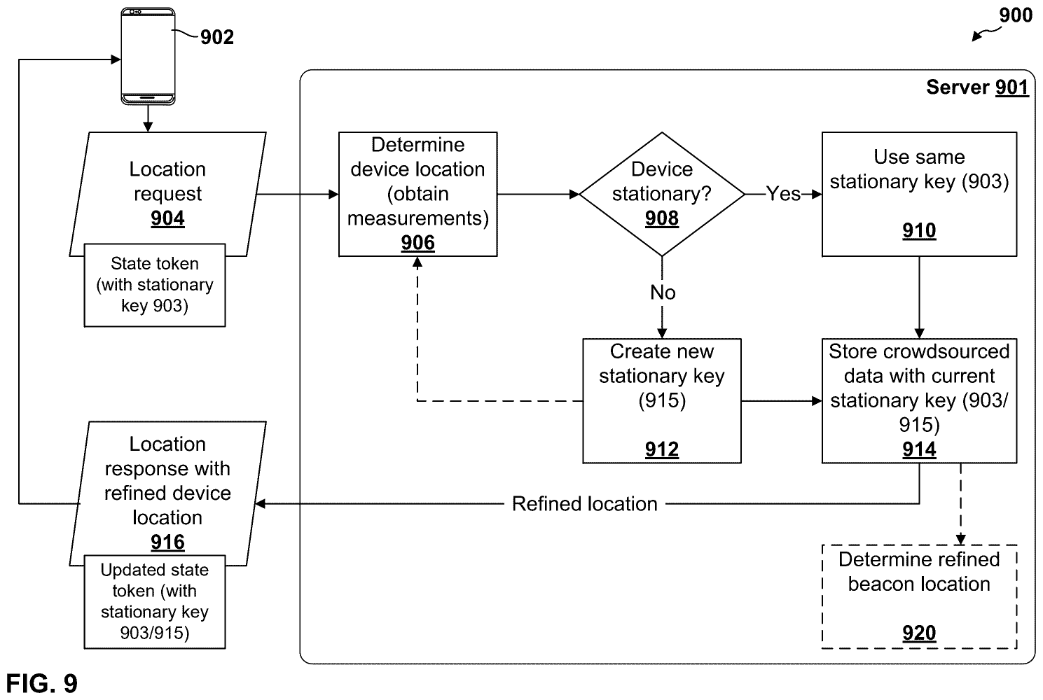

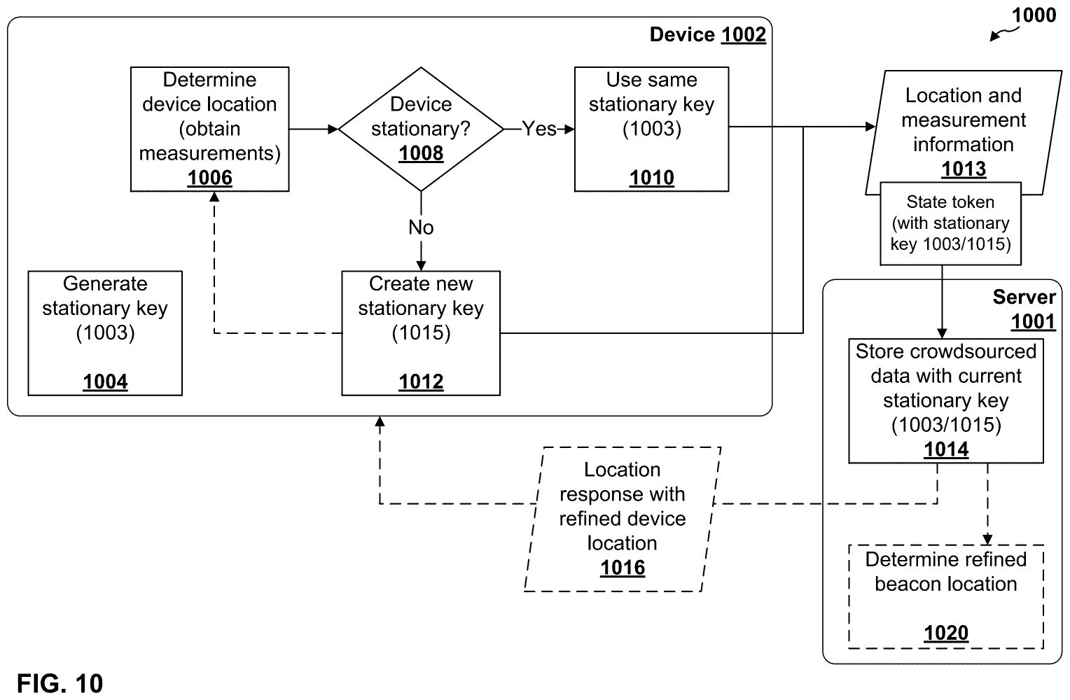

In particular embodiments, a “stationary key” may be an example of a state token. As will become clear based on the present disclosure, a stationary key may in some cases be a piece of information that corresponds to and can be associated with a location of a device. Determination of the device's location and whether a device considered stationary are described in further detail with respect to FIGS. 9 and 10. Advantageously, such a stationary key may not include any identifying information of the device, such as a device identifier (ID), which maintains the privacy or anonymity of the device and/or its user within crowdsourced data or other aggregate data, such as a body of information relating to positioning measurements (which may be stored or accessible by, e.g., a server).

To enhance privacy and anonymity of a device and/or its user, a stationary key may be unique within a network. That is, it is an aim that no two devices managed by a server(s) of a network may have the same stationary key. When a server generates the stationary keys, it can ensure the uniqueness by virtue of awareness of which keys have been generated and is being used. When a device generates the stationary keys, it can use one or more techniques that minimize the chances of generating a key that is identical to another key within the network (which are described elsewhere herein, including an irreversible hash, a sufficient length, etc.). In some approaches, only devices that are currently present within a given network may be associated with keys that are unique to one another. In some cases, such keys may not be unique compared to a key used in another network, so a device that moves to another network or connects to another server in some cases may be associated with a key that is similar or identical compared to a key used in the previous network. This also means that, in some implementations, a stationary key that was once associated with a location of a device that is no longer within the network may be reused in the future within the network. By extension, a device that moves to another location in which it connects to another network may conceivably generate or receive the same stationary key that it has been associated with before, although the chances are miniscule. It is notable that the chances of two (or more) devices within a network having the same stationary key at any given time may be low by virtue of, e.g., pseudorandom or random nature of generating the stationary keys, and/or the length of the stationary key sufficiently reducing the chances of random or psuedorandom generation resulting in duplicate keys. For instance, as an example of a stationary key, a 128-character alphanumeric string may be generated by the server or the device psuedorandomly and/or based on other factors as mentioned herein (see, e.g., below). This way, the identity of the device can be obfuscated within an aggregated or crowdsourced set of information such as positioning measurement data relating to the device, and it becomes difficult or impossible to identify or track the device within such data.

In some cases, some previously used stationary keys, such as those that have been associated with a location of a device in the past but is no longer associated because the device has moved outside the location or is no longer present or operational within the network, may become available for association again but only after a certain period of time has passed (e.g., after a certain number of hours, days, weeks, months, years, etc. since the device has left the network). Conversely, in some cases, as discussed elsewhere herein, stationary keys may be discarded or disabled (and newly generated) after a certain period of time has passed, regardless of other triggers such as a distance threshold or position uncertainty. Ultimately, while stationary keys are and should be highly unique to one another, they may be flexible enough that a key need not be unique compared to all networks for all time.

These key management approaches may apply to other types of keys or state data as discussed elsewhere herein (e.g., a “dwelling key” or an “identification key”).

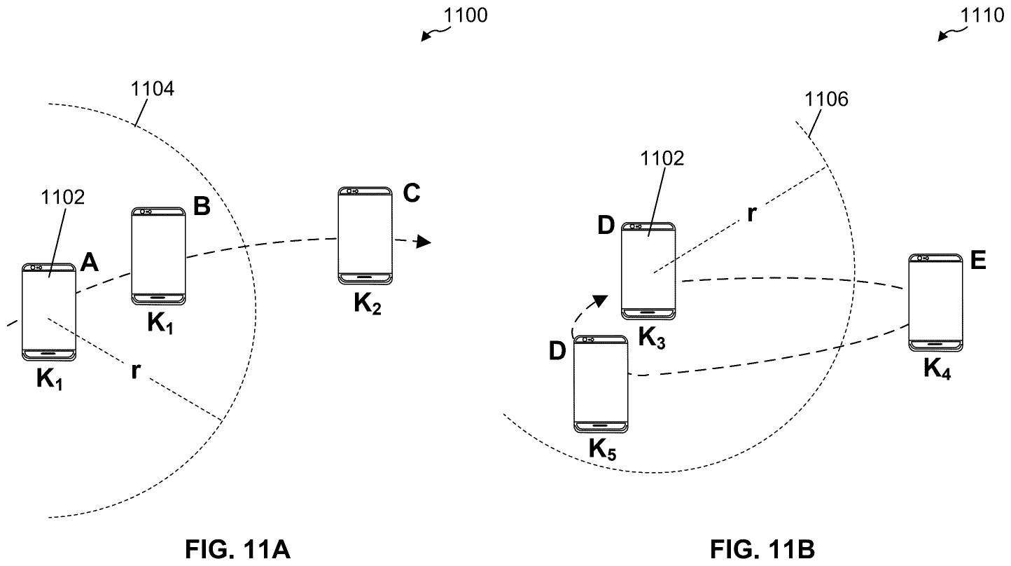

In some approaches, the key may be generated by a server (e.g., a location server) or the device itself. In some implementations, the key may be generated pseudorandomly (or randomly), generated based on one or more measurements made or otherwise obtained by the device, and/or generated based on one or more properties associated with the device (e.g., motion or lack of sufficient motion, change in location or lack thereof, direction, pose, type of device, capabilities), network (including devices of the network), region, environment, other devices, and/or other elements (e.g., time of day, week, month, year, etc.). In some implementations, the key may be generated with an irreversible hashing function of a parameter of the device (e.g., device ID), or based on some transient or dynamic condition (time of day, time since device has been turned on, including minutes or seconds value, etc.). The state of the device may change, such as its position, and thus, the stationary key may be newly generated based on various conditions or triggers. For example, if the device is considered to be in a different location (e.g., based on exceeding a distance threshold or another condition), the device or a network entity such as a location server may generate a new stationary key. Even if the device returns to its initial location (as illustrated in the examples of FIGS. 11A and 11B), the device can be considered a new device at every new change in location with a new stationary key distinct to other stationary keys. In another example of conditions or triggers or bases for generating a new stationary key to rotate the stationary key, if a position uncertainty is exceeded.

To ensure security and privacy associated with a location request, aspects provided herein may encode information for providing the location into a state token in a location request, and the location server may respond with another state token. By way of example, the state token may include a location history, uncertainties, confidence metrics, historical location related measurements associated with the device (which may include measurements obtained by the network device or measurements obtained by other network entities based on signals transmitted by the device), state machine values, probabilities, and aggregations of these values, unique information or a unique key associated with the device, or the like. The state token may be persisted (e.g., stored) at the device (e.g., or a separate device associated with the device that is not located at the device or the location server) but not the location server, enabling location servers based on state tokens that do not include a device identifier associated with the device.

As used herein, the term “location server” may refer to a collection of one or more servers that may collectively receive a location request associated with a device and provide location information associated with the device to the device or a separate device associated with (e.g., that may be in communication with) the device. Location server 160 or external client 180 may be examples of a location server or one or more such servers.

As used herein, the term “location request” may refer to a request transmitted from a device (or another device associated with the device) to a location server to request a location associated with the device. The device may transmit the location request to the location server via one or more intermediaries, such as one or more network nodes, another server, or the like. A transmission may be referred to as “transmitted from the device to the location server” if the transmission originates from the device (or another device associated with the device) and eventually arrives at the location server. In some aspects, a location request may include a state token associated with the device.

As used herein, the term “location response” may refer to a response transmitted from a location server to a device (or another device associated with the device) to provide location information associated with the device. The location server may transmit the location response to the device (or another device associated with the device) via one or more intermediaries, such as one or more network nodes, another server, or the like. A transmission may be referred to as “transmitted from the location server for/to the device” if the transmission originates from the location server and eventually arrives at the device (or another device associated with the device). In some aspects, a location response may include a state token associated with the device. In some aspects, the state token may include location information associated with a device.

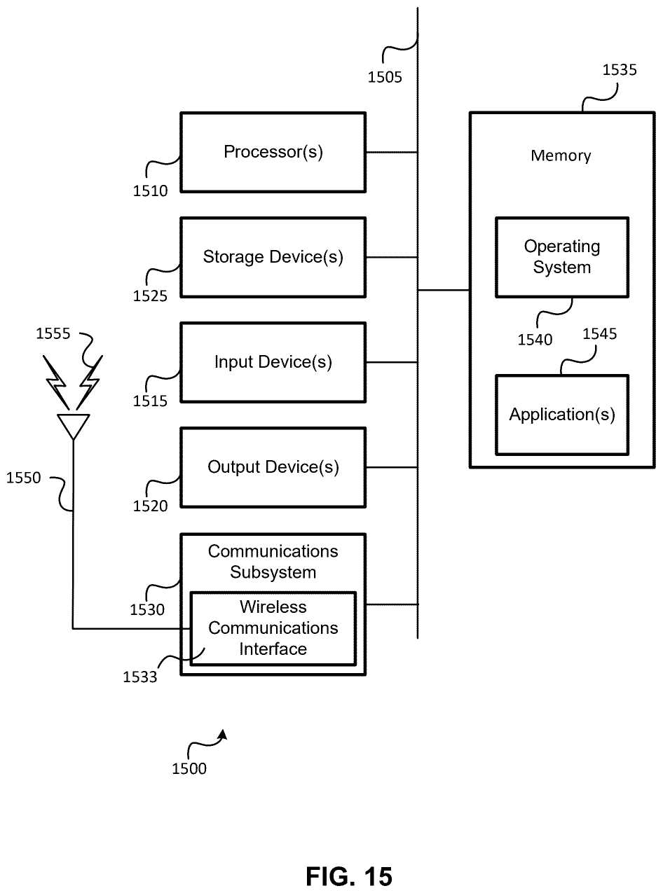

Note that in some configurations of the network, a crowdsourcing server (e.g., crowdsourcing server 161 shown in FIG. 1) may be disposed within the network separately from a location server (e.g., location server 160). In some implementations, the crowdsourcing server may be configured to receive measurement data, location data, state data (e.g., state ID, stationary key, stateful components) from one or more or numerous (e.g., thousands, millions) devices in the network. Such a crowdsourcing server may also store the data and/or send the data to another network entity (e.g., the location server) or provide access to the data to another network entity. In some configurations, the crowdsourcing server may be disposed in the backend of the network infrastructure and communicatively coupled to the location server. In some configurations, the crowdsourcing server may be disposed as an intermediary network entity or an edge node, closer to the user devices (e.g., where devices are concentrated or available), end terminals, base stations, etc. In some configurations, the crowdsourcing server may be part of the location server. In some cases, the location server and the crowdsourcing server may include substantially similar functionalities and components (e.g., as shown in FIG. 15).

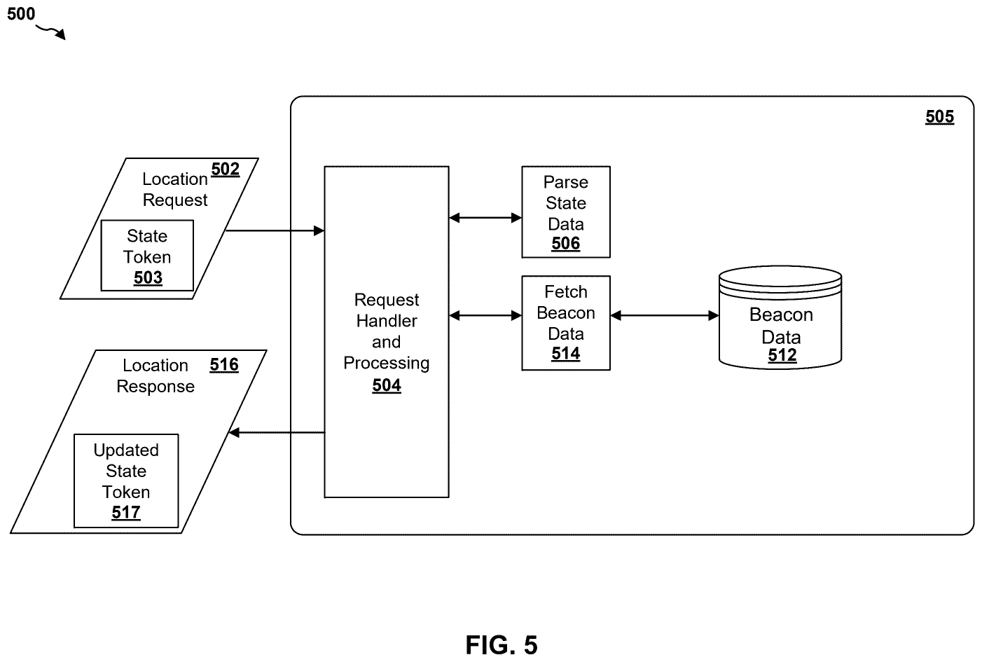

FIG. 5 is a diagram 500 illustrating an example of processing a location request and providing a location response based on a state token. As illustrated in FIG. 5, a location request 502 that includes a state token 503 may be transmitted to a request handler and processing 504 at a location server 505. The location server 505 may parse state data in the state token 503 at 506, which may parse the one or more elements included in the state token. The state token 503 and the location request 502 may include location related signal measurements associated with a one or more beacons. Based on the location related signal measurements, the server may fetch, at 514, beacon data 512 which may include beacon position data related to the location related signal measurements in order to determine a location, e.g., according to the approach discussed with respect to the example beacon-based positioning scenario 400 shown in FIG. 4. The beacon data 512 may include, by way of example, positions of access points (APs), positions of cell antenna(s), or centroid of coverage of APs and cells for the beacons measured (e.g., by the device or another device). The beacon data 512 may also include GNSS satellite ephemeris data. The beacon data 512 may also include positions of device(s) measuring the beacons. After determining the location information, the location information may be included in an updated state token 517 that may be included in a location response 516 transmitted by the location server 505 for a device (which may be transmitted to the device or another device).

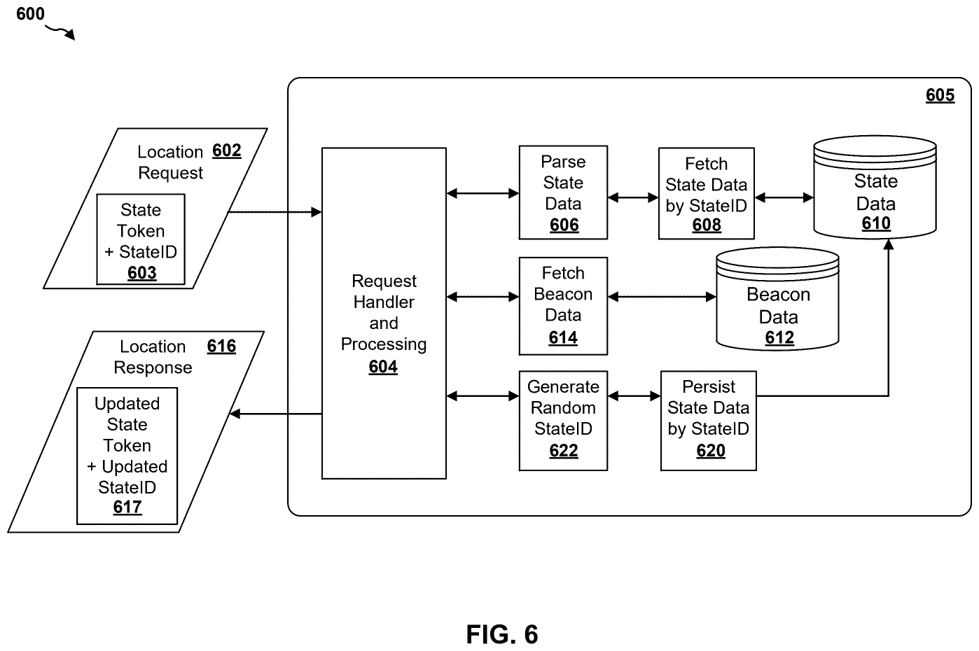

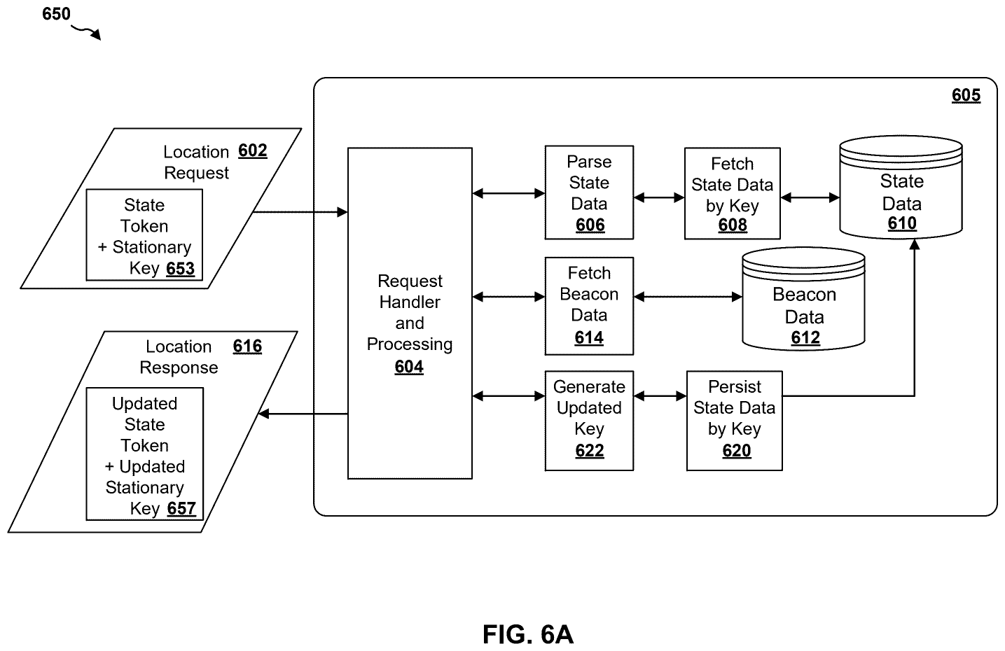

FIG. 6 is a diagram 600 illustrating an example of processing a location request and providing a location response based on a state token including a state ID. As illustrated in FIG. 6, a location request 602 that includes a state token 603 may be transmitted to a request handler and processing 604 at a location server 605. The state token 603 may include a state ID. The location server 605 may parse state data in the state token 603 at 606, which may parse the one or more elements included in the state token. The state token 603 and the location request 602 may include location related signal measurements associated with a one or more beacons. Based on the location related signal measurements, the server may fetch, at 614, beacon data 612 which may include beacon position data related to the location related signal measurements in order to determine a location, e.g., according to the approach discussed with respect to the example beacon-based positioning scenario 400 shown in FIG. 4. The beacon data 612 may include, by way of example, positions of APs, positions of cell antenna(s), or centroid of coverage of APs and cells for the beacons measured (e.g., by the device or another device). The beacon data 612 may also include GNSS satellite ephemeris data. The beacon data 612 may also include positions of device(s) measuring the beacons. After determining the location information, in some aspects, the location server 605 may generate a state ID at 622 and persist (e.g., temporarily store) the location information as state data 610 at 620 based on the generated state ID. For example, the location server 605 may temporarily store the state data due to a device configured to receive the location response 616 including the state token 617 based on the stored state data may be offline. The location server 605 may temporarily store the state data to wait for the device to come online, fetch state data at 608, then transmit the location response 616 including the state token 617.

FIG. 6A is a diagram 650 illustrating an example of processing a location request and providing a location response based on a state token including stationary key information. Similar to FIG. 6, a location request 602 that includes a state token 603 may be transmitted to a request handler and processing 604 at a location server 605. Stationary key information or a stationary key may be an example of a state ID. Thus, the state token 603 may include a stationary key 653, which may be representative of a state of the requesting device, or a stateful component thereof. More specifically, the stationary key 653, as described elsewhere herein, may be a unique piece of information that represents whether the device has moved sufficiently but does not identify the device (if identifying information of the device (e.g., a device ID) is not sent to the location server 605). The location server 605 may parse state data in the stationary key 653 at 606, which may parse the one or more elements included in the stationary key 653. The stationary key 653 and the location request 602 may include unique information associated with the location of the device. The key may be unique to the device without identifying the device, and associated with the location of the device. The location request 602 may also include location related signal measurements associated with one or more beacons, e.g., at the location of the device (similar to FIG. 6A), which may be associated with the unique information. Based on the location related signal measurements associated with the unique information, the server may fetch, at 614, beacon data 612 which may include beacon position data related to the location related signal measurements in order to determine a location, e.g., according to the approach discussed with respect to the example beacon-based positioning scenario 400 shown in FIG. 4. The beacon data 612 may include, by way of example, positions of APs, positions of cell antenna(s), or centroid of coverage of APs and cells for the beacons measured (e.g., by the device or another device). The beacon data 612 may also include GNSS satellite ephemeris data. The beacon data 612 may also include positions of device(s) measuring the beacons. After determining the location information, in some aspects, the location server 605 may generate a new or updated stationary key 657 at 622 and persist (e.g., temporarily store) the location information as state data 610 at 620 based on the generated updated stationary key 657. In some implementations, the updated stationary key 657 may be generated based on one or more conditions described elsewhere herein, for example, if the movement of device has exceeded a distance threshold or a position uncertainty has been exceeded. For example, the location server 605 may temporarily store the state data due to a device configured to receive the location response 616 including the updated stationary key 657 based on the stored state data may be offline. The location server 605 may temporarily store the state data to wait for the device to come online, fetch state data at 608, then transmit the location response 616 including the updated stationary key 657.

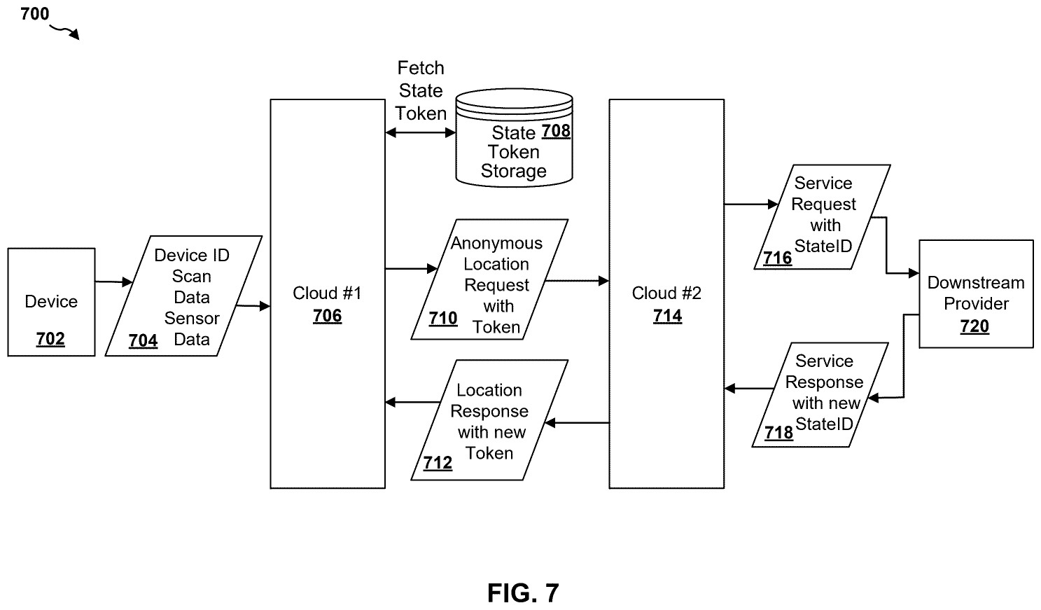

FIG. 7 is a diagram 700 illustrating an example of an architecture associated with providing location information to a device. As illustrated in FIG. 7, the device 702 may provide data 704 including device ID, device scan data, and sensor data to a first cloud server 706 associated with the device 702. The first cloud server 706 may store state token(s) associated with the device 702 at state token storage 708. The first cloud server 706 may transmit location request 710 to a second cloud server 714, which may be part of the location server. The location request 710 may include state token associated with the device 702 and may not include the device ID. Upon receiving the location request 710, the cloud server 714 may transmit a service request 716 with a state ID associated with the state token included in the location request 710 to a downstream provider 720 (e.g., which may be part of the location server) to fetch various location information and may receive a service response 718 associated with a new state ID. The cloud server 714 may transmit a location response 712 based on a new state token generated based on the fetched location information back to the cloud server 706. In some aspects, the downstream provider may be part of the location server and may be connected to the second cloud server 714.

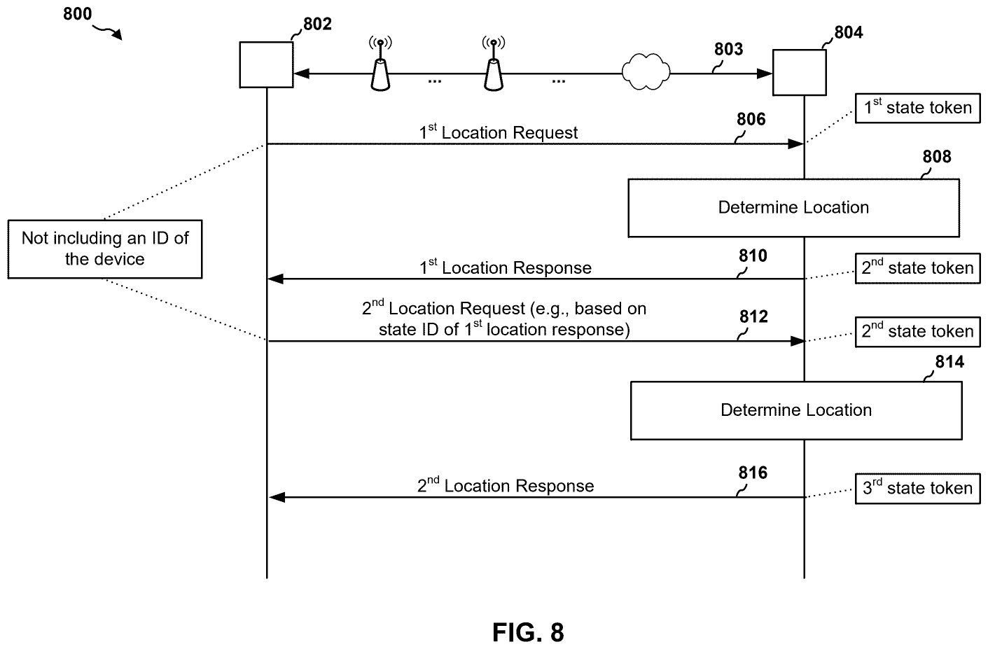

FIG. 8 is a diagram 800 illustrating example communications between a location server 804 and a device 802. As illustrated in FIG. 8, communications between the location server 804 and the device 802 may be facilitated by connection 803 that may be enabled based on one or more other network nodes, network entities, servers, or the like. Communications between the location server 804 and the device 802 may be based on wireless communication, wired communication, or a mixture of wireless communication and wired communication. According to embodiments, the device 802 may include a UE or a another server. As illustrated in FIG. 8, the device 802 may transmit a location request 806 to the location server 804 to request location information associated with the device 802. In some aspects, the location request 806 may include a state token and may not include an identifier (e.g., device ID) that may allow the location server 804 to determine multiple location requests or state tokens to be associated with the same device 802. In some aspects, the location request 806 may be a first location request in a configured period of time. In such aspects, the location request 806 may include a null state token. In some aspects, there may be a prior location request/response during the configured period of time. In such aspects, the location request 806 may include a most recently received state token (e.g., in a prior location response). The location request 806 may correspond to the location request 502, the location request 602, or the location request 710. The location response 810 may correspond to the location response 516, the location response 616, or the location response 712.

In some aspects, as previously described, a state token may include one or more elements associated with a device for the purpose of requesting a location. The one or more elements may include one or more of a last (which may also be referred to as “most recent”) location associated with the device, a last serving cell associated with the device, confidence metrics and uncertainties associated with a calculated device location (or associated with the most recent location), the calculated device location, a last location provided by the location server, one or more accumulated measurement of beacon signals that includes one or more previous geo-spatial positioning results, one or more positions determined based on a positioning mechanism (e.g., and associated confidence metrics or uncertainties), a state ID, a weight associated with samples, calculated device locations, the one or more positions, unique information or a unique key associated with the device, or the like. The state token may not include an identifier (e.g., device ID) that allows the location server 804 to determine multiple location requests or state tokens to be associated with the same device 802.

As illustrated in FIG. 8, at 808, after receiving the location request 806, the location server 804 may determine location information associated with the device 802, such as by parsing state data associated with the state token included in the location request 806 and fetching signal data, as described in connection with FIGS. 5-7. In some aspects, the location server 804 may generate a second state token and transmit the second state token in a first location response 810 for the device 802 (e.g., which may be transmitted to the device 802 or a different device, such as another server). In some aspects, the first state token and the second state token do not include a state ID. In some aspects, the first state token may include a first state ID and the second state token may include a second state ID. A state ID may be generated by the location server 804 and may be uniquely associated with the state token. In some aspects, the location server 804 may delete a received state token in the location request 806 after generating the state token to be transmitted in the location response 810. In some aspects, upon receiving the location response 810 and the second state token, the device 802 (or a device associated with the device 802) may store the second state token.

In some aspects, at some time after receiving the location response 810, the device 802 may transmit a second location request 812 to request updated location information associated with the device 802. In some aspects, the second location request 812 may include the second state token that was previously included in the location response 810 and stored by the device 802 may not include an identifier (e.g., device ID). In some aspects, the second location request 812 may also include the second state ID because the second state token includes the second state ID. In some aspects, upon receiving the second location request 812, the location server 804 may again determine location information associated with the device 802 at 814 and may generate a third state token. In some aspects, the location server 804 may delete the second state token upon generating the third state token and may transmit a location response 816 for the device 802 (e.g., which may be transmitted to the device 802 or a different device, such as another server) that includes the third state token. The location request 812 may correspond to the location request 502, the location request 602, or the location request 710. The location response 816 may correspond to the location response 516, the location response 616, or the location response 712.

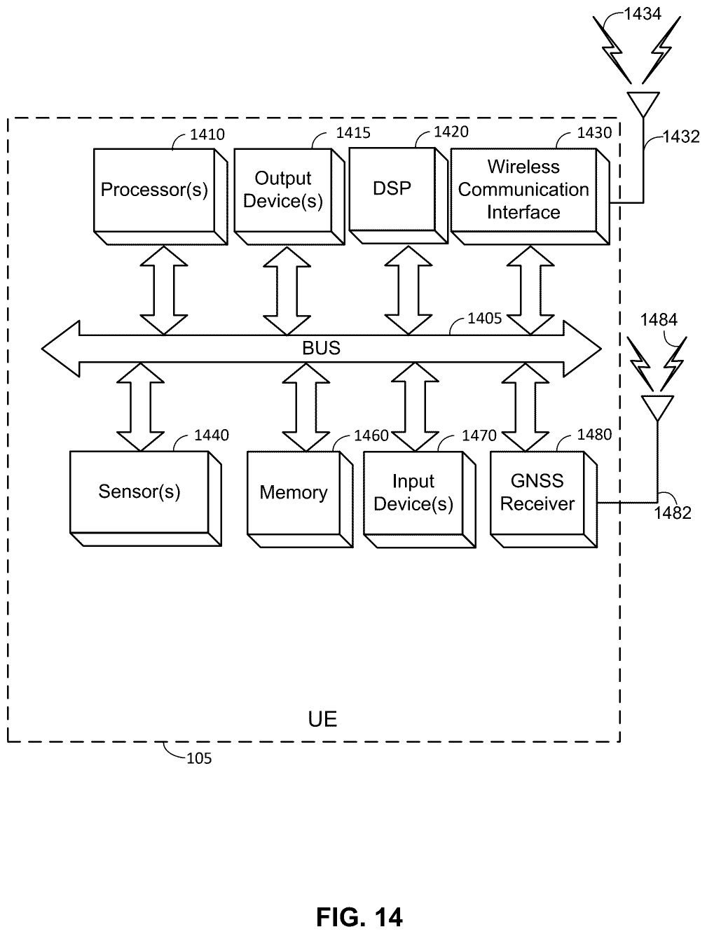

FIG. 9 is a flow diagram of an example process 900 for location determination of a device within a wireless network, according to some embodiments. Structure for performing the functionality illustrated in one or more of the blocks shown in FIG. 9 may be performed by hardware and/or software components of a computer system or a network apparatus, e.g., a location server. Components of such computer system or network apparatus may include, for example, one or more transceivers, one or more data communication interfaces, one or more memory, one or more processors, and/or a computer-readable apparatus including a storage medium storing computer-readable and/or computer-executable instructions that are configured to, when executed by one or more processors, cause the one or more processors or the computer system or the network apparatus to perform operations represented by blocks below. Example components of a UE are illustrated in FIG. 14, described in more detail below. Example components of a location server are illustrated in FIG. 15, described in more detail below. It should also be noted that the operations of FIG. 9 may be performed in any suitable order, not necessarily the order depicted in FIG. 9. Further, the process shown in FIG. 9 may include additional or fewer operations than those depicted in FIG. 9.

In some scenarios, a device 902 (e.g., a UE) may send a location request 904 to a network entity such as a server 901 (e.g., location server 160). In some implementations, the location request 904 may be an example of the location request 502, the location request 602 (shown in FIG. 6 or 6A), or the location request 710. Location request 904 may include a state token, which may include unique information associated with the device 902. The unique information may be embodied as a unique key associated with the device 902. In some implementations, the value of the unique key may depend on a state of the device 902, e.g., whether the device 902 is stationary or nonstationary. Such a unique key may be referred to as a “stationary key” as discussed herein.

In some cases, the device 902 may create a stationary key 903 substantially concurrently with the location request 904, or some time prior to sending the location request 904 to the network entity so that the stationary key 903 may be included with the location request 904 (e.g., included with a data structure such as a packet for the location request 904) or sent separately but associated with the location request 904 (e.g., the stationary key 903 may identify the location request 904, or vice versa, or may be sent consecutively with or within a certain time period relative to the location request 904). As alluded to above, the stationary key 903 may be generated randomly or pseudorandomly, based on one or more positioning measurements obtained by the device, and/or based on one or more measurements or properties of the device 902. Moreover, the stationary key 903 may not identify the device 902.

At block 906, the server 901 may determine or estimate the location of the device 902. In some implementations, for a set or subset of location records with an identical stationary key 903, a new computed location from some or all of those records could be determined by smoothing, averaging, or otherwise aggregating the set of locations, or computing a new computed location having a higher accuracy (and/or lower error) from the set of individual measurements, advantageously without identifying the device 902 and thereby overcoming the aforementioned current limitation of a single location attempt that limits the accuracy of the location. This procedure may result in provision of the new computed location (e.g., with a location response 916 to the device 902).

Location determination at block 906 may be accomplished in various ways and via various types of measurements. For example, beacon-based measurements and position may be obtained using, e.g., the example beacon-based positioning scenario 400 shown in FIG. 4. It will be recognized that server 901 may perform other positioning techniques or take one or more various types of measurements (such as RTT, TDOA, AoA, AoD, beamforming, signal strength/power/quality, or a combination thereof, among others) via one or more wireless protocols and/or technologies to obtain the location. In some implementations, multiple determinations or estimations and/or sets of measurements may be made by the server 901. Multiple location determinations may result in a few, numerous, or many location records associated with stationary key 903. Measurements obtained at a location that has the same stationary key 903 would be used to generate the location estimations, which would be presumed to be from what is considered the same location, since the same stationary key 903 would, e.g., indicate that movement of the device 902 has not exceeded a distance threshold or position uncertainty. Location determinations may be performed periodically or a certain number of times in some cases. Location determinations may be performed over a period of time in some cases.

At decision diamond 908, the server 901 may determine whether the device 902 is stationary. In some implementations, the server 901 may compare two or more location determinations made in block 906 to one another. In some implementations, the server 901 may compare the location determination in block 906 with a previous location determination (e.g., determined prior to location request 904). In some implementations, the server 901 may determine a current location of the device 902 (e.g., using the ways mentioned above) to evaluate decision diamond 908, separate from the location determination in block 906. Thus, at least two location determinations for the device 902 (including one reference location such as a previous location determination) may be made and compared in decision diamond 908.

In some implementations, the device 902 may be considered stationary or not based on a threshold. For example, a determination that the device 902 is stationary may be determined based on the change of the location of the device 902 not exceeding a threshold, or a determination that the device 902 is nonstationary may be determined based on the change of the location of the device 902 exceeding a threshold. In some implementations, the threshold may be a distance threshold relative to a reference location, which may be the position or location of the device 902 at the time of the location request 904 (which may be the first of a set of location determinations). In some cases, to reduce false positives, the threshold may require exceeding multiple times (e.g., multiple location records are distinctly different from others), where such multiple times is selected randomly, above a certain quantity, based on desired sensitivity of the determination, or a combination thereof. In some cases, exceeding the threshold too much as to be an outlier (e.g., past a certain standard deviation, threshold, multiple; or physically improbable based on timestamps) may be ignored, although multiple outliers detected may indicate that the location of the device 902 has indeed changed. In some cases, the threshold may be based on time or include a time threshold. The time threshold may correspond to a time limit or a period of time. During the period of time, it may be determined that the device 902 is considered stationary if the change of the location of the device 902 does not exceed the distance threshold, and not stationary if the change of the location exceeds the distance threshold, as discussed above. Stated another way, the stationary key 903 may be considered valid only during the period of time. If the time threshold is exceeded, the device 902 may be considered not stationary, or the stationary key 903 may expire and a new stationary key 915 may be created (e.g., in block 912). That is, decision diamond 908 may proceed to block 912 to create a new stationary key regardless of whether or not the distance threshold is exceeded, if the period of time has passed. This approach to rotating the stationary key to a new one more often may further prevent or reduce the likelihood that the device 902 is associated with the measurements or location determinations.

In some cases, the distance threshold may be selected or adjusted depending on the type of positioning method used, or a type of signal used by the device to obtain one or more positioning measurements. Some positioning methods may be associated with different levels of accuracy or reliability. For example, GNSS accuracy may be on the order of 5-10 meters, while Wi-Fi RSSI may be on the order of 25-50 meters, and cellular-based RSSI position may be within 100-200 meters.

In some cases, the distance threshold may be selected or adjusted depending on the technology used by the device 902 (such as a type of wireless communication or wireless communication protocol), e.g., to obtain measurements for location determination at block 906. By way of a comparative example, if the device 902 used cellular-based positioning, the selected distance threshold may be about 100-200 meters, or if the device 902 used GNSS, the selected distance threshold may be about 5-10 meters.

In some implementations, the device 902 may be considered stationary or not based on a velocity of the device 902 (e.g., a velocity greater than a threshold). In some implementations, the device 902 may be considered stationary or not based on variations in Doppler frequency measurements (e.g., variations greater than a threshold), which may be indicative of motion. In other implementations, other indications such as a motion status of the device 902 may also be considered.

Put another way, evaluating the decision diamond 908 may include determining whether it has moved from the reference location sufficiently since the location request 904. This determination may be based on any location(s) determined at block 906, or in cases of multiple location determinations at block 906, the reference location may be an average, centroid, median, a weighted version of the foregoing, or another aggregate metric. In some approaches, the threshold may be dynamically determined based on a network condition, or a type of environment (e.g., urban jungle vs. an open field). A lower threshold may be more appropriate where a higher precision would be useful, such as densely populated or commercial areas. In some implementations, the device 902 may be considered stationary or not based on an estimated position uncertainty, which may be determined dynamically for each position attempt. For instance, movement of the device 902 exceeding the position uncertainty may result in the device 902 being considered non-stationary.

At block 910, if it is determined that the device is stationary, the same stationary key 903 created and included with the location request 904 may be stored and associated with the location records from block 906. That is, the same stationary key 903 may be maintained and used as long as the device 902 is considered stationary.

Although device 902 cannot be traced from request to request based only on the state token and stationary key, device 902 may still be vulnerable to derivation of identity in certain situations. Consider a situation in which one and only one device is known to arrive at a venue every day at a certain time (7:45 AM) and is stationary until a certain time (4:00 PM), e.g., a security guard posted in front of an entrance. This knowledge may enable a system or person to map that device to a specific user or location.

Hence, in some approaches, the stationary key 903 may still be refreshed (newly generated) or rotated at certain time intervals or with a random time interval (e.g., based on random jitter or noise or other randomness). In some approaches, refreshing the stationary key 903 may be triggered only if a known location pattern is detected (e.g., 7:45 AM to 4:00 PM) and/or if there is only one device in an area of interest. Alternatively, instead of forgoing key persistence as above, persistence of a stationary key may be limited to certain times of day. In some approaches, the device 902 may wait for a number of location determination samples (where such a number may be random) after becoming stationary before allowing a stationary key to become persistent, which may obfuscate arrival time. These approaches may further increase anonymity of the device 902 beyond a pure stationary check (e.g., at decision diamond 908).

Additionally, a stationary state of a device may not necessarily indicate a lack of motion or travel. A device that is in motion but not traveling to different determined locations may retain the same stationary key and also retain its anonymity. Consider a device that is pushed back and forth on a table or moving in a small circle. Such a device may still be considered stationary at block 910, e.g., if the change of the location of the device 902 does not exceed the threshold. Also consider a set of devices attached to objects in a warehouse, or mobile phones of users in an office during the workday. If the device 902 were at a public place with many other devices with a similar stationary profiles, or were one of the devices in the foregoing office example, it could be very difficult to identify that particular device 902 or the associated user if it retains the same stationary key.

Nevertheless, in some approaches, another stateful component of a state token (other than a stationary key) may be defined. For instance, the stationary state of the device may be extended (or narrowed) to a specified place, such as a surrounding zone, region, building, or other feature of the environment (e.g., walls, buildings, landmarks), where the device may be considered stationary despite any motion within the specified place. Such a stateful component, referred to herein as a “dwelling key” for the purposes of defining the stationary state of the device, may be defined by location samples remaining within a certain proximity of one another (e.g., within a second distance threshold), which may indicate whether the device 902 is remaining (dwelling) at the specified place. A dwelling key may be a unique piece of information associated with the device 902, similar to the stationary key, generated while dwelling at the specified place. Thus, in some implementations, the device 902 may be associated with both a stationary key and a dwelling key, each of which may be refreshed or rotated independently while the other remains persistent. However, anonymity may only be as restrictive as the most permissive rotation strategy (one that allows the most freedom in movement), and the most permissive strategy may be configured to trigger a rotation of the other key(s) to prevent accidental overlap in tracing of the device.

On the other hand, some situations may warrant not triggering a key rotation to promote the anonymity of the device 902. For example, if the identity of the device 902 (or a subset of devices of a plurality of devices) is already known and/or if the device 902 is always in a fixed position (e.g., UE installed in a building or associated with a venue, or a reference UE whose location and measurements are tracked to verify the location of other UEs), then it may not be necessary to generate stationary keys or other unique identifiers. The server 901 may have awareness of the identity and/or location of the device 902. For instance, server 901 may have the information (e.g., in a lookup table) or may have generated other state data or state component for known devices. Such state component may be a unique or non-unique identifier, which can be called an “identification key” associated with a device or devices that need not be anonymized. Hence, in addition to a stationary key and/or a dwelling key, an identification key may be generated and associated with a device or devices. In cases where a device or devices are associated with an identification key, the example process 900 may conclude at decision diamond 908, or skip decision diamond 908 to proceed with providing a location response with a refined device location (at block 916) but without an updated stationary key.

At block 912, if it is determined that the device is not stationary, the server 901 may create a new stationary key 915. Although, as with stationary key 903, the new stationary key 915 may be generated randomly or pseudorandomly, based on one or more measurements obtained by the device, and/or generated based on one or more measurements or properties of the device 902, new stationary key 915 will be a unique key that is different and distinguishable from stationary key 903 and not associated to the stationary key 903. That is, the stationary key 903 (or the identity of the device 902) will not be derivable from the new stationary key 915 (or vice versa).

Hence, different stationary keys may be used depending on whether the device 902 is considered stationary or to have moved sufficiently. More specifically, the stationary key 903 may be used to link together locations of the device 902 from its initial location (e.g., at the time of the location request 904 or location determination block 906), only when they are stationary. This stationary key 903 will remain constant for a given device across locations if the device is determined to be stationary. The new stationary key 915 may be used to link together locations of the device 902 at a new location that is not the initial location. This new stationary key 915 will also remain constant only while at locations considered to be the new location. Any previous stationary key such as stationary key 903 will no longer be used to associate with new or future locations.

Referring briefly to FIG. 11A, an example scenario 1100 of a device 1102 that is considered stationary and not stationary is illustrated. The device 1102 may be associated with a first stationary key K1, which may correspond to position A of the device 1102. A distance threshold 1104 may be selected, determined, prescribed, or otherwise identified. In some examples, the distance threshold 1104 may be a radius r identified around the device 1102, while at position A in this case. In some cases, the distance threshold 1104 may be changed or updated depending on factors mentioned above regarding a dynamically determined threshold. In the example scenario 1100, the device 1102 may move to position B. However, position B of the device 1102 may not exceed the distance threshold 1104. Hence, a location server may retain and continue associating its location determinations of the device 1102 with the first stationary key K1. That is, measurements taken at K1 will be associated with the same location of the device 1102. The device 1102 may move to position C outside the distance threshold 1104. Since position C is outside of the distance threshold 1104, the location server (or device) may create a new stationary key, a second stationary key K2 associated with a new location (e.g., position C). K2 is a unique key that is different from any previous or future keys of the device 1102 and those of any other device in the network. If the handling of the keys is performed by the network (e.g., the location server), it is able to generate keys that are unique across all devices in the network without duplicate or overlapping keys. If the device 1102 generates the new unique key, it can also create a key that is sufficiently unique, as will be discussed below.

Referring briefly to FIG. 11B, an example scenario 1110 of the device 1102 that is not considered stationary is illustrated. The device 1102 may be associated with a third stationary key K3, which may correspond to position D of the device 1102. After the device 1102 is determined to have moved beyond a distance threshold 1106 to position E, the location server (or the device 1102) may create a fourth stationary key K4 associated with a new location (e.g., position E). K4 is distinct from any previous or future keys of the device 1102 and any other device in the network. After the device 1102 is determined to have moved back to position D (or proximate to it, e.g., within the distance threshold 1106), the location server (or the device 1102) may create a fifth stationary key K5 that is distinct from any previous or future keys of the device 1102 and any other device in the network. However, K5 and measurements made at position D may be associated with position D.

In other words, the device 1102 is considered to be a new device when it sufficiently changes location or moves (e.g., beyond a threshold), even if it later returns to the same location, which may further frustrate identification of the device 1102. Whether a stationary key is created may be assessed each time the device 1102 determines or estimates a location. When the device 1102 positions itself, it may compare the current position to just computed to previous position, and determine whether or not it is stationary (e.g., based on the threshold). If the device 1102 is determined to be stationary, the location server may retain and use the stationary key it already has associated with the positioning measurements. If it's not, the location server (or the device 1102) may create a new stationary key.

Returning back to FIG. 9, at block 914, the then-current stationary key, which may be the stationary key 903 or the new stationary key 915 depending on whether the device 902 is considered stationary or not, may be stored with crowdsourced data at the network entity (e.g., location server), or in other implementations, a storage device associated with the network entity. The crowdsourced data may include various types of data, including the measurement(s) and determined location(s) from block 906. The crowdsourced data may further include location data or measurements associated with one or more other devices, beacons (e.g., base stations, APs, Bluetooth-enabled nodes), and/or other network devices. The more measurements and data aggregated in the body/bodies of crowdsourced data at the network entity, the more accurate a location solution may become.

In some embodiments, a location response 916 may be sent to the device 902. The location response 916 may be an example of the location response 516, the location response 616 (shown in FIG. 6 or 6A), or the location response 712. Location response 916 may include an updated state token, which may include unique information associated with the device 902, its location, and positioning measurement(s) at the location. Here, the unique information may include the stationary key 903 or the new stationary key 915. The location response 916 may include location information associated with the device 902 which is refined over individual location determinations and measurements such as those determined at block 906. Refined location information associated with the device 902 and in the location response 916 may be based on the crowdsourced data, e.g., aggregated or computed as mentioned above. Location and measurement data with respect to the device 902 may be associated with the stationary key 903 or the new stationary key 915, but not the identity of the device 902, thereby enabling identity-free crowdsourcing of the location and measurement data. In some approaches, the server 901 may generate a request (including while the location request 904 is still pending) to collect more measurements.

In some scenarios, at block 920, a refined location of one or more beacons may be determined. In some implementations, the refined location of a beacon (e.g., base station, AP, Bluetooth-enabled node such as those discussed with respect to FIG. 4) may be determined based on the crowdsourced data stored at the network entity. For example, the refined location of the device 902 and/or measurement data used to derive the refined location can be applied to the beacon measurements across a set of location records associated with a given stationary key (903 or 915), when used to compute and update beacon positions. In particular, referring back to FIG. 4, d1, d2 and/or d3 can become more accurate with a more accurate position of the device 902. In this way, the position of a beacon can become more accurate.

In some implementations, the measurement of specific beacons across this set of location records can be combined (e.g., smoothed, averaged, median filtered, earliest arrival for timing measurements, or another aggregation method applied). The resulting beacon measurements may be more accurate, associated with more accurate device locations, and used to generate a more accurate beacon location database, without compromising, or even with an increase in the privacy, identity, or anonymity of device 902.

FIG. 10 is a flow diagram of an example process 1000 for location determination of a device within a wireless network, according to some embodiments. Structure for performing the functionality illustrated in one or more of the blocks shown in FIG. 10 may be performed by hardware and/or software components of a computer system or a network apparatus, e.g., a UE. Components of such computer system or network apparatus may include, for example, one or more transceivers, one or more data communication interfaces, one or more memory, one or more processors, and/or a computer-readable apparatus including a storage medium storing computer-readable and/or computer-executable instructions that are configured to, when executed by one or more processors, cause the one or more processors or the computer system or the network apparatus to perform operations represented by blocks below. Example components of a UE are illustrated in FIG. 14, described in more detail below. It should also be noted that the operations of FIG. 10 may be performed in any suitable order, not necessarily the order depicted in FIG. 10. Further, the process shown in FIG. 10 may include additional or fewer operations than those depicted in FIG. 10.

In some embodiments, at block 1004, the device 1002 may create a stationary key 1003. As alluded to above, the stationary key 1003 may be generated randomly or pseudorandomly, based on one or more measurements obtained by the device, and/or based on one or more measurements or properties of the device 1002. Moreover, the stationary key 1003 may not identify the device 1002.

In some implementations, the stationary key 1003 may be created to be sufficiently long (e.g., above a prescribed length threshold) so that the chance of a duplicate key within the network is remote. In some implementations, the stationary key 1003 may be created with an irreversible hashing function of a parameter of the device (e.g., device ID). In some implementations, the stationary key 1003 may be created based on some transient or dynamic condition (e.g., time of day, time since device 1002 has been turned on, including minutes or seconds value). One or more of the above may be combined to create sufficient uniqueness of the stationary key 1003 such that no two device within the network would be associated with the same key or such that the likelihood is extremely low. Contrast with the example process 900 described above, where the server 901 can create keys based on its awareness of which keys have been generated already and thus can ensure that keys are unique within the network.

At block 1006, the device 1002 may determine or estimate its own location. This may be done using one or more positioning measurements obtained by the device 1002 and a positioning technique described elsewhere herein (e.g., the example beacon-based positioning scenario 400 shown in FIG. 4, RTT, TDOA, AoA, AoD, beamforming, signal strength/power/quality, or a combination thereof). In some implementations, multiple determinations or estimations and/or sets of measurements may be made by the device 1002. Multiple location determinations may result in a few, numerous, or many location records associated with stationary key 1003. Measurements obtained at a location that has the same stationary key 1003 would be used to generate the location estimations, which would be presumed to be from what is considered the same location, since the same stationary key 1003 would, e.g., indicate that movement of the device 1002 has not exceeded a distance threshold or position uncertainty.

In some implementations, for a set or subset of location records with an identical stationary key 1003, a new computed location from some or all of those records could be determined by smoothing, averaging, or otherwise aggregating the set of locations, or computing a new computed location having a higher accuracy (and/or lower error) from the set of individual measurements, advantageously without identifying the device 1002 and thereby overcoming the aforementioned current limitation of a single location attempt that limits the accuracy of the location. This procedure may result in provision of the new computed location as needed or desired (e.g., with a location response 1016 to the device 1002).

At decision diamond 1008, the device 1002 may determine whether it is stationary. In some implementations, the device 1002 may compare two or more location determinations made in block 1006 to one another. In some implementations, the device 1002 may compare the location determination in block 1006 with a previous location determination. A previous location may have been determined at block 1004 after generating the stationary key 1003. In some implementations, the device 1002 may determine a current location of the device 1002 (e.g., using the ways mentioned above) to evaluate decision diamond 1008, separate from the location determination in block 1006. Thus, at least two location determinations for the device 1002 (including one reference location such as a previous location determination) may be made and compared in decision diamond 1008.

In alternate approaches, a server 1001 (e.g., location server 160) may compute the location of the device 1002 (based, e.g., on the obtained one or more measurements, which may have been sent to the server 1001) and send the location back to the device 1002. Hence, the device 1002 may determine whether to update the stationary key 1003 based on its own location (as discussed above) or based on the location that is determined or estimated by the server 1001 and sent to the device 1002.

In some implementations, the device 1002 may be considered stationary or not based on a threshold. For example, a determination that the device 1002 is stationary may be determined based on the change of the location of the device 1002 not exceeding a threshold, or a determination that the device 1002 is nonstationary may be determined based on the change of the location of the device 1002 exceeding a threshold. As discussed above, the threshold may be a distance threshold in some implementations. In some cases, the distance threshold may be selected or adjusted depending on the type of positioning method used, a type of signal used by the device to obtain one or more positioning measurements, or the technology used by the device 1002. In some implementations, the threshold may be a time threshold. In some implementations, the device 1002 may be considered stationary or not based on a velocity of the device 1002 (e.g., a velocity greater than a threshold). In some implementations, the device 1002 may be considered stationary or not based on variations in Doppler frequency measurements (e.g., variations greater than a threshold), which may be indicative of motion. In other implementations, other indications such as a motion status of the device 1002 may also be considered. In some approaches, the threshold may be dynamically determined based on a network condition, or a type of environment (e.g., urban jungle vs. an open field).

At block 1010, if it is determined that the device is stationary, the same stationary key 1003 created may be associated with the location records and information from block 1006, including, e.g., measurements obtained and location information determined by the device 1002. That is, the same stationary key 1003 may be maintained and used as long as the device 1002 is considered stationary.

In some approaches, another stateful component of a state token (other than a stationary key) may be defined and associated with the location information, such as a dwelling key and/or an identification key as described above. In alternative approaches, rotation or generation of the aforementioned keys may not be triggered, as described above.

At block 1012, if it is determined that the device is not stationary, the device 1002 may create a new stationary key 1015. As with stationary key 1003, the new stationary key 1015 may be generated randomly or pseudorandomly, based on one or more measurements obtained by the device, and/or generated based on one or more measurements or properties of the device 1002. The new stationary key 1015 may be created to be sufficiently long (e.g., above a prescribed length) so that the chance of a duplicate within the network is remote. In some implementations, the new stationary key 1015 may be created with an irreversible hashing function of a parameter of the device (e.g., device ID). In some implementations, the new stationary key 1015 may be created based on some transient or dynamic condition (e.g., time of day, time since device 1002 has been turned on, including minutes or seconds value). It is an objective of this approach that new stationary key 1015 will be a unique key that is different and distinguishable from stationary key 1003 and not associated to the stationary key 1003. That is, the stationary key 1003 (or the identity of the device 1002) should not be derivable from the new stationary key 1015, or vice versa.

In some embodiments, location information 1013 may be sent to the server 1001, along with state data such as a stationary key 1003 or 1015. The stationary key may be the same one generated in block 1004 (stationary key 1003) or generated in block 1012 responsive to a change in location (stationary key 1015). The measurements and location information 1013 sent by the device 1002 may be associated with the stationary key 1003 or 1015, meaning that the location information 1013 does not contain information specifically identifying the device 1002, which maintains and promotes the anonymity of the device 1002 and/or its activity or location so that it cannot be tracked within the crowdsourced data stored at or accessible by the server 1001.

Hence, different stationary keys may be used depending on whether the device 1002 is considered stationary or to have moved sufficiently. More specifically, the stationary key 1003 may be used to link together locations of the device 1002 from its initial location (e.g., at the time of the location request 1004 or location determination block 1006), only when they are stationary. This stationary key 1003 will remain constant for a given device across locations if the device is determined to be stationary. The new stationary key 1015 may be used to link together locations of the device 1002 at a new location that is not the initial location. This new stationary key 1015 will also remain constant only while at locations considered to be the new location. Refer also to FIGS. 11A and 11B for scenarios illustrating when new stationary keys may be generated by the device 1002.

1014, 1016 and 1020 performed at the server 1001 may be substantially similar to corresponding elements 914, 916 and 920 as described above.

At block 1014, the then-current stationary key, which may be the stationary key 1003 or the new stationary key 1015 depending on whether the device 1002 is considered stationary or not, may be stored with crowdsourced data at the network entity (e.g., location server), or in other implementations, a storage device associated with the network entity.

In some embodiments, optionally, a location response 1016 may be sent to the device 1002. The location response 1016 may be an example of the location response 516, the location response 616 (shown in FIG. 6 or 6A), or the location response 712. The location response 1016 may include a refined location of the device, which as discussed above may be computed and determined based on aggregate crowdsourced data that is stored or accessible by the server 1001. The refined location may include location information associated with the device 1002 which is refined over individual location determinations and measurements such as those determined at block 1006. The measurements and location information 1013 sent by the device 1002 may be associated with a stationary key 1003 or 1015 that does not identify the device 1002, maintaining and promoting anonymity of the device 1002 and/or its activity or location so that it cannot be tracked within the crowdsourced data.

In some scenarios, at block 1020, a refined location of one or more beacons may be determined.

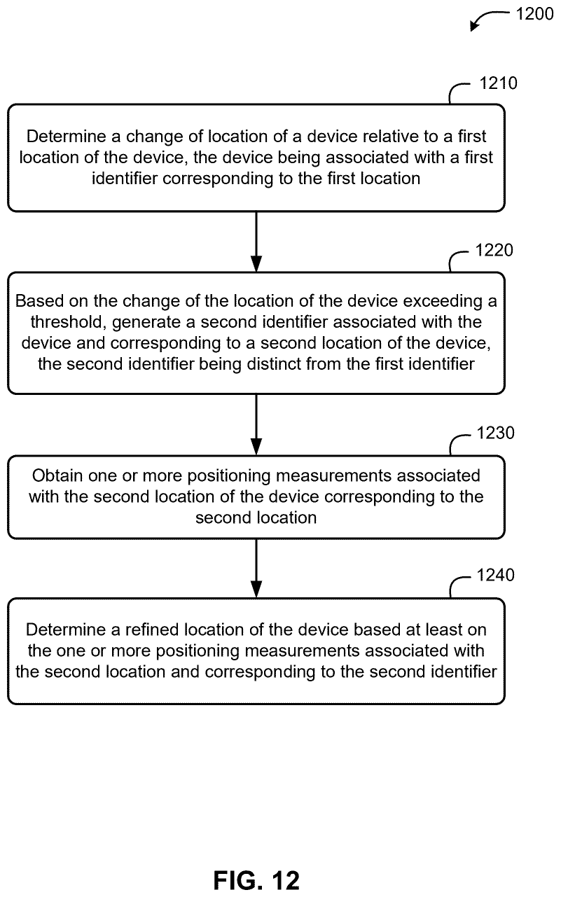

FIG. 12 is a flow diagram of a method 1200 for location determination of a device within a wireless network, according to some embodiments. Structure for performing the functionality illustrated in one or more of the blocks shown in FIG. 12 may be performed by hardware and/or software components of a computer system or a network apparatus, e.g., a location server. In some embodiments, the network apparatus may include a server, such as a location server 160, LMF 220, location server 505, location server 605, or location server 804. Components of such computer system or network apparatus may include, for example, one or more transceivers, one or more data communication interfaces, one or more memory, one or more processors, and/or a computer-readable apparatus including a storage medium storing computer-readable and/or computer-executable instructions that are configured to, when executed by one or more processors, cause the one or more processors or the computer system or the network apparatus to perform operations represented by blocks below. Example components of a location server are illustrated in FIG. 15, described in more detail below. It should also be noted that the operations of FIG. 12 may be performed in any suitable order, not necessarily the order depicted in FIG. 12. Further, the process shown in FIG. 12 may include additional or fewer operations than those depicted in FIG. 12.

At block 1210, the functionality of method 1200 may include determining a change of location of the device relative to a first location of the device, the device being associated with a first identifier corresponding to the first location. In some embodiments, the functionality of method 1200 may further include receiving from the device a request to determine the refined location of the device. In some implementations, the request may include the first identifier corresponding to the first location. In some implementations, the determining of the change of location may be responsive to the request received from the device to determine a refined location of the device.

Means for performing functionality at block 1210 may include processor(s) 1510, a communications subsystem 1530, working memory 1535, and/or other components of a computer system, as illustrated in FIG. 15.

At block 1220, the functionality of method 1200 may include, based on the change of the location of the device exceeding a threshold, generating a second identifier associated with the device and corresponding to a second location of the device, the second identifier being distinct from the first identifier. In some embodiments, each of the first identifier and the second identifier may be based on a pseudorandom generation. In some implementations, the first identifier and the second identifier may be configured to prevent identification of the device by excluding identifying information of the device (e.g., device ID). In some embodiments, each of the first identifier and the second identifier may be a stationary key of the type disclosed herein. Hence, in some embodiments, the first identifier and the second identifier may be unique to one another and across all keys associated with locations and/or devices within the network.

In some embodiments, the threshold may include a distance threshold. In some embodiments, the threshold may be determined based on a position uncertainty of the device at the first location of the device, a network condition, a type of environment of the first location of the device, or a combination thereof. In some implementations, the distance threshold may be determined based at least on a type of positioning method used by the device to obtain the one or more positioning measurements, a type of signal used by the device to obtain the one or more positioning measurements, or a combination thereof. In some embodiments, the threshold may be based on a type of wireless communication used by the device. By way of a comparative example, if the device used cellular-based positioning, the distance threshold may be about 100-200 meters, or if the device used GNSS, the distance threshold may be about 5-10 meters. In some implementations, the threshold may be based on a position uncertainty. That is, for a device to be considered non-stationary, the device must have moved a distance exceeding the position uncertainty.

In some implementations, the generating of the second identifier may be further based on a time threshold defined by a period of time during which the first identifier is valid.

Means for performing functionality at block 1220 may include processor(s) 1510 and/or other components of a computer system, as illustrated in FIG. 15.

At block 1230, the functionality of method 1200 may include obtaining one or more positioning measurements associated with the second location of the device corresponding to the second identifier. In some implementations, the determining of the refined location of the device may be further based at least on one or more other positioning measurements obtained via crowdsourcing with respect to one or more other devices within the wireless network. The one or more other positioning measurements obtained by one or more other devices may correspond to measurements taken at a location associated with the second identifier (e.g., the second location) but not associated with the second identifier, since different devices will not be associated with the same identifier (e.g., stationary key). Depending on the application, the refined location of the device may be determined by averaging, smoothing, filtering, and/or applying other aggregation methods listed elsewhere herein to at least on one or more other positioning measurements obtained at the second location associated with the second identifier, one or more other positioning measurements obtained by one or more other devices, or a combination thereof.

In some embodiments, the obtaining of the one or more positioning measurements may include obtaining one or more positioning measurements made using one or more wireless signals via a wireless local area network (WLAN) (e.g., Wi-Fi), a cellular protocol, Bluetooth-based protocol, Ultra Wideband (UWB) protocol, a satellite system, or a combination thereof. A magnet field may also be used in some cases.

In some embodiments, the one or more positioning measurements may include a signal timing measurement, a signal strength measurement, a signal angle measurement, or a combination thereof. Examples of a signal timing measurement may include (and not be limited to) RTT, TOA, and TDOA. Examples of a signal strength measurement may include (and not be limited to) RSRP, RSSI, or other power or quality measurements. Examples of a signal angle measurement may include (and not be limited to) AoA, AoD, or direction.

Means for performing functionality at block 1230 may include processor(s) 1510, a communications subsystem 1530, and/or other components of a computer system, as illustrated in FIG. 15.

At block 1240, the functionality of method 1200 may include determining a refined location of the device based at least on the one or more positioning measurements associated with the second location of the device and corresponding to the second identifier.

Means for performing functionality at block 1240 may include processor(s) 1510 and/or other components of a device such as a computer system, as illustrated in FIG. 15.

In some embodiments, method 1200 may further include sending the refined location of the device to the device. The refined location of the device may be included with a location response, which may also include the second identifier (e.g., an updated stationary key).

In some embodiments, method 1200 may further include obtaining one or more positioning measurements associated with the first location, and determining the first location of the device based on the one or more positioning measurements associated with the first location. In some embodiments, method 1200 may further include determining the second location based on the one or more positioning measurements associated with the second location. In some implementations, the determining of the change of location of the device may include comparing the first location of the device with the second location of the device to determine the change in the location of the device.

In some embodiments, method 1200 may further include obtaining one or more additional positioning measurements associated with the second location. In some implementations, the determining of the refined location of the device may be based on the one or more positioning measurements associated with the second location and the one or more additional positioning measurements associated with the second location.

In some embodiments, method 1200 may further include obtaining one or more positioning measurements associated with the first location; and receiving the first identifier corresponding to the first location from the device. In some implementations, the device may be associated with the first identifier while the device is at the first location and the change of the location of the device does not exceed the threshold.

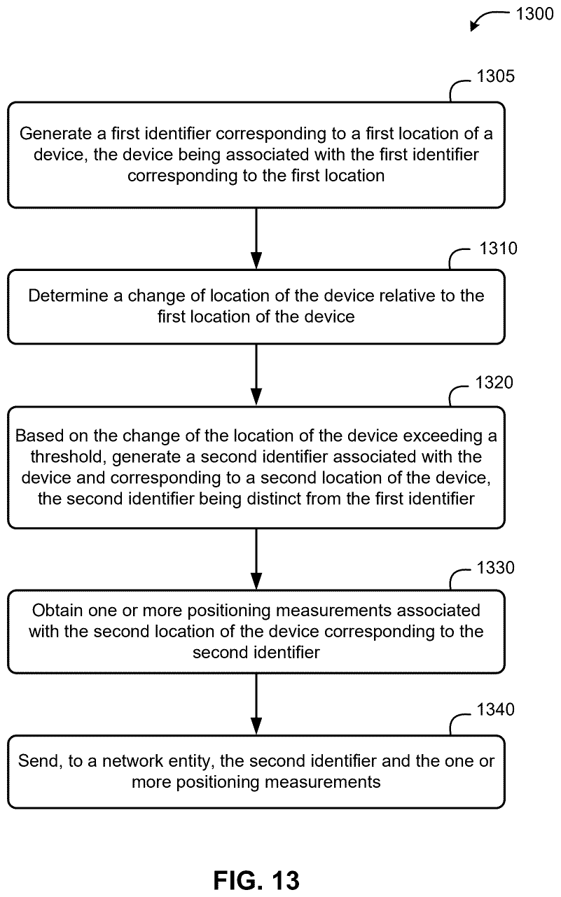

FIG. 13 is a flow diagram of a method 1300 for location determination of a device within a wireless network, according to some embodiments. Structure for performing the functionality illustrated in one or more of the blocks shown in FIG. 13 may be performed by hardware and/or software components of a computer system or a network apparatus, e.g., a UE. In some embodiments, the network apparatus may include a device 702, device 802, device 1002, or device 1102. Components of such a device may include, for example, one or more transceivers, one or more data communication interfaces, one or more memory, one or more processors, and/or a computer-readable apparatus including a storage medium storing computer-readable and/or computer-executable instructions that are configured to, when executed by one or more processors, cause the one or more processors or the device to perform operations represented by blocks below. Example components of a device are illustrated in FIG. 14, described in more detail below. It should also be noted that the operations of FIG. 13 may be performed in any suitable order, not necessarily the order depicted in FIG. 13. Further, the process shown in FIG. 13 may include additional or fewer operations than those depicted in FIG. 13.

At block 1305, the functionality of method 1300 may include generating, by the device, a first identifier corresponding to a first location of the device, the device being associated with a first identifier corresponding to the first location. In some embodiments, an example of the first identifier may be a stationary key as discussed herein.

At block 1310, the functionality of method 1300 may include determining, by the device, a change of location of the device relative to the first location of the device. For example, this change of location may be determined by comparing the first location with another location that is determined by the device subsequent to determination of the first location.

Means for performing functionality at block 1310 may include processor(s) 1410, a communications interface 1430, memory 1460, and/or other components of a UE, as illustrated in FIG. 14.

At block 1320, the functionality of method 1300 may include, based on the change of the location of the device exceeding a threshold, generating, by the device, a second identifier associated with the device and corresponding to a second location of the device, the second identifier being distinct from the first identifier. In different implementations, each of the first identifier and the second identifier may be based on: a pseudorandom generation; an irreversible hashing function of a parameter of the device; a transient condition that is unrelated to the device or related to the device; a length that meets or exceeds a threshold; or a combination thereof.

In some embodiments, the threshold may include a distance threshold; the threshold is determined based on a position uncertainty of the device at the first location of the device, a network condition, a type of environment of the first location of the device, or a combination thereof; or a combination thereof. In some embodiments, the generating of the second identifier may be further based on a time threshold defined by a period of time during which the first identifier is valid.

In some embodiments, the device may be associated with the first identifier while the device is at the first location and the change of the location of the device does not exceed the threshold.

Means for performing functionality at block 1320 may include processor(s) 1410 and/or other components of a UE, as illustrated in FIG. 14.

At block 1330, the functionality of method 1300 may include obtaining, by the device, one or more positioning measurements associated with the second location of the device corresponding to the second identifier.

In some implementations, the distance threshold may be determined based at least on a type of positioning method used by the device to obtain the one or more positioning measurements, a type of signal used by the device to obtain the one or more positioning measurements, or a combination thereof.

In some embodiments, the one or more positioning measurements may include a signal timing measurement, a signal strength measurement, a signal angle measurement, or a combination thereof.

In some embodiments, the obtaining of the one or more positioning measurements may include obtaining one or more positioning measurements made using one or more wireless signals via a wireless local area network (WLAN), a cellular protocol, Bluetooth-based protocol, an Ultra Wideband (UWB) protocol, a satellite system, or a combination thereof.

Means for performing functionality at block 1330 may include processor(s) 1410, a communications interface 1430 and/or other components of a UE, as illustrated in FIG. 14.

At block 1340, the functionality of method 1300 may include sending, to a network entity, the second identifier and the one or more positioning measurements. In some embodiments, the sending of the second identifier and the one or more positioning measurements to the network entity may include enabling the network entity to associate the one or more positioning measurements with the second identifier without identifying the device in a set of positioning measurements crowdsourced from the device and at least one other device within the wireless network.

Means for performing functionality at block 1340 may include a communications interface 1430 and/or other components of a UE, as illustrated in FIG. 14.

Optionally, in some embodiments, the functionality of method 1300 may further include receiving, from the network entity, a refined location of the device. In some embodiments, the refined location of the device may be based on the obtained one or more positioning measurements and one or more positioning measurements obtained via crowdsourcing from at least one other device within the wireless network.

In some embodiments, method 1300 may further include obtaining one or more positioning measurements associated with the first location, and determining the first location of the device based on the one or more positioning measurements associated with the first location. In some implementations, method 1300 may further include determining the second location based on the one or more positioning measurements associated with the second location. In some approaches, the determining of the change of location of the device may include comparing the first location of the device with the second location of the device to determine the change in the location of the device.

In some embodiments, method 1300 may further include obtaining one or more positioning measurements associated with the first location; and determining the change of the location of the device based on the one or more positioning measurements associated with the first location and the one or more positioning measurements associated with the second location of the device.

### Apparatus

FIG. 14 is a block diagram of an embodiment of a UE 105, which can be utilized as described herein above (e.g., in association with FIGS. 4-9). For example, the UE 105 can perform one or more of the functions of the methods shown in FIG. 9. It should be noted that FIG. 14 is meant only to provide a generalized illustration of various components, any or all of which may be utilized as appropriate. It can be noted that, in some instances, components illustrated by FIG. 14 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 14.

The UE 105 is shown comprising hardware elements that can be electrically coupled via a bus 1405 (or may otherwise be in communication, as appropriate). The hardware elements may include a processor(s) 1410 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1410 may comprise one or more processing units, which may be housed in a single integrated circuit (IC) or multiple ICs. As shown in FIG. 14, some embodiments may have a separate DSP 1420, depending on desired functionality. Location determination and/or other determinations based on wireless communication may be provided in the processor(s) 1410 and/or wireless communication interface 1430 (discussed below). The UE 105 also can include one or more input devices 1470, which can include without limitation one or more keyboards, touch screens, touch pads, microphones, buttons, dials, switches, and/or the like; and one or more output devices 1415, which can include without limitation one or more displays (e.g., touch screens), light emitting diodes (LEDs), speakers, and/or the like.

The UE 105 may also include a wireless communication interface 1430, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 1430 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1432 that send and/or receive wireless signals 1434. According to some embodiments, the wireless communication antenna(s) 1432 may comprise a plurality of discrete antennas, antenna arrays, or any combination thereof. The antenna(s) 1432 may be capable of transmitting and receiving wireless signals using beams (e.g., Tx beams and Rx beams). Beam formation may be performed using digital and/or analog beam formation techniques, with respective digital and/or analog circuitry. The wireless communication interface 1430 may include such circuitry.

Depending on desired functionality, the wireless communication interface 1430 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 1440. Sensor(s) 1440 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 1480 capable of receiving signals 1484 from one or more GNSS satellites using an antenna 1482 (which could be the same as antenna 1432). Positioning based on GNSS signal measurement can be utilized to complement and/or incorporate the techniques described herein. The GNSS receiver 1480 can extract a position of the UE 105, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1480 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1480 is illustrated in FIG. 14 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1410, DSP 1420, and/or a processor within the wireless communication interface 1430 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1410 or DSP 1420.

The UE 105 may further include and/or be in communication with a memory 1460. The memory 1460 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1460 of the UE 105 also can comprise software elements (not shown in FIG. 14), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1460 that are executable by the UE 105 (and/or processor(s) 1410 or DSP 1420 within UE 105). In some embodiments, then, such code and/or instructions can be used to configure and/or adapt a general-purpose computer (or other device) to perform one or more operations in accordance with the described methods.

A set of these instructions and/or code might be stored on a non-transitory computer-readable storage medium, such as the storage device(s) described above. In some cases, the storage medium might be incorporated within a computerized device, such as UE 105. In other embodiments, the storage medium might be separate from the device (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the UE 105 and/or might take the form of source and/or installable code, which, upon compilation and/or installation on the UE 105 (e.g., using any of a variety of generally available compilers, installation programs, compression/decompression utilities, etc.), then takes the form of executable code.

FIG. 15 is a block diagram of an embodiment of a computer system 1500, which may be used, in whole or in part, to provide the functions of one or more network components as described in the embodiments herein (e.g., location server 160 of FIG. 1). For example, the computer system 1500 can perform one or more of the functions of the method shown in FIGS. 9 and 12. It should be noted that FIG. 15 is meant only to provide a generalized illustration of various components, any or all of which may be utilized as appropriate. FIG. 15, therefore, broadly illustrates how individual system elements may be implemented in a relatively separated or relatively more integrated manner. In addition, it can be noted that components illustrated by FIG. 15 can be localized to a single device and/or distributed among various networked devices, which may be disposed at different geographical locations.

The computer system 1500 is shown comprising hardware elements that can be electrically coupled via a bus 1505 (or may otherwise be in communication, as appropriate). The hardware elements may include processor(s) 1510, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1500 also may comprise one or more input devices 1515, which may comprise without limitation a mouse, a keyboard, a camera, a microphone, and/or the like; and one or more output devices 1520, which may comprise without limitation a display device, a printer, and/or the like.

The computer system 1500 may further include (and/or be in communication with) one or more non-transitory storage devices 1525, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1500 may also include a communications subsystem 1530, which may comprise wireless communication technologies managed and controlled by a wireless communication interface 1533, as well as wired technologies (such as Ethernet, coaxial communications, universal serial bus (USB), and the like). The wireless communication interface 1533 may comprise one or more wireless transceivers that may send and receive wireless signals 1555 (e.g., signals according to 5G NR or LTE) via wireless antenna(s) 1550. Thus the communications subsystem 1530 may comprise a modem, a network card (wireless or wired), an infrared communication device, a wireless communication device, and/or a chipset, and/or the like, which may enable the computer system 1500 to communicate on any or all of the communication networks described herein to any device on the respective network, including a User Equipment (UE), base stations and/or other TRPs, and/or any other electronic devices described herein. Hence, the communications subsystem 1530 may be used to receive and send data as described in the embodiments herein.

In many embodiments, the computer system 1500 will further comprise a working memory 1535, which may comprise a RAM or ROM device, as described above. Software elements, shown as being located within the working memory 1535, may comprise an operating system 1540, device drivers, executable libraries, and/or other code, such as one or more applications 1545, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method for location determination of a device within a wireless network, the method comprising: generating, by the device, a first identifier corresponding to a first location of the device, the device being associated with a first identifier corresponding to the first location; determining, by the device, a change of location of the device relative to the first location of the device; based on the change of the location of the device exceeding a threshold, generating, by the device, a second identifier associated with the device and corresponding to a second location of the device, the second identifier being distinct from the first identifier; obtaining, by the device, one or more positioning measurements associated with the second location of the device corresponding to the second identifier; and sending, to a network entity, the second identifier and the one or more positioning measurements.
Clause 2. The method of clause 1, further comprising receiving, from the network entity, a refined location of the device.
Clause 3. The method of clause 2, wherein the refined location of the device is based on the obtained one or more positioning measurements and one or more positioning measurements obtained via crowdsourcing from at least one other device within the wireless network.
Clause 4. The method of clause 1, wherein the sending of the second identifier and the one or more positioning measurements to the network entity comprises enabling the network entity to associate the one or more positioning measurements with the second identifier without identifying the device in a set of positioning measurements crowdsourced from the device and at least one other device within the wireless network.
Clause 5. The method of clause 1, wherein each of the first identifier and the second identifier is based on: a pseudorandom generation; an irreversible hashing function of a parameter of the device; a transient condition that is unrelated to the device or related to the device; a length that meets or exceeds a threshold; or a combination thereof.
Clause 6. The method of clause 1, wherein: the threshold comprises a distance threshold; the threshold is determined based on a position uncertainty of the device at the first location of the device, a network condition, a type of environment of the first location of the device, or a combination thereof; or a combination thereof.
Clause 7. The method of clause 6, wherein the distance threshold is determined based at least on a type of positioning method used by the device to obtain the one or more positioning measurements, a type of signal used by the device to obtain the one or more positioning measurements, or a combination thereof.
Clause 8. The method of clause 6, wherein the generating of the second identifier is further based on a time threshold defined by a period of time during which the first identifier is valid.
Clause 9. The method of clause 1, further comprising obtaining one or more positioning measurements associated with the first location, and determining the first location of the device based on the one or more positioning measurements associated with the first location.
Clause 10. The method of clause 9, further comprising determining the second location based on the one or more positioning measurements associated with the second location; wherein the determining of the change of location of the device comprises comparing the first location of the device with the second location of the device to determine the change in the location of the device.
Clause 11. The method of clause 1, wherein the one or more positioning measurements comprise a signal timing measurement, a signal strength measurement, a signal angle measurement, or a combination thereof.
Clause 12. The method of clause 1, wherein the obtaining of the one or more positioning measurements comprises obtaining one or more positioning measurements made using one or more wireless signals via a wireless local area network (WLAN), a cellular protocol, Bluetooth-based protocol, an Ultra Wideband (UWB) protocol, a satellite system, or a combination thereof.
Clause 13. The method of clause 1, further comprising: obtaining one or more positioning measurements associated with the first location; and determining the change of the location of the device based on the one or more positioning measurements associated with the first location and the one or more positioning measurements associated with the second location of the device.
Clause 14. The method of clause 1, wherein the device is associated with the first identifier while the device is at the first location and the change of the location of the device does not exceed the threshold.
Clause 15. A device comprising: one or more transceivers configured for data communication with a network entity; one or more memory; and one or more processors communicatively coupled to the one or more transceivers and the one or more memory, the one or more processors configured to: generate a first identifier corresponding to a first location of the device, the device being associated with a first identifier corresponding to the first location; determine a change of location of the device relative to the first location of the device; based on the change of the location of the device exceeding a threshold, generate a second identifier associated with the device and corresponding to a second location of the device, the second identifier being distinct from the first identifier; obtain one or more positioning measurements associated with the second location of the device corresponding to the second identifier; and send, to a network entity, the second identifier and the one or more positioning measurements.
Clause 16. The device of clause 15, wherein the sending of the second identifier and the one or more positioning measurements to the network entity comprises enabling the network entity to associate the one or more positioning measurements with the second identifier without identifying the device in a set of positioning measurements crowdsourced from the device and at least one other device within the wireless network.
Clause 17. The device of clause 15, wherein: the threshold comprises a distance threshold; the threshold is determined based on a position uncertainty of the device at the first location of the device, a network condition, a type of environment of the first location of the device, or a combination thereof; or a combination thereof.
Clause 18. A device comprising: means for generating a first identifier corresponding to a first location of the device, the device being associated with a first identifier corresponding to the first location; means for determining a change of location of the device relative to the first location of the device; means for, based on the change of the location of the device exceeding a threshold, generating a second identifier associated with the device and corresponding to a second location of the device, the second identifier being distinct from the first identifier; means for obtaining one or more positioning measurements associated with the second location of the device corresponding to the second identifier; and means for sending, to a network entity, the second identifier and the one or more positioning measurements.
Clause 19. The device of clause 18, wherein the means for sending of the second identifier and the one or more positioning measurements to the network entity comprises means for enabling the network entity to associate the one or more positioning measurements with the second identifier without identifying the device in a set of positioning measurements crowdsourced from the device and at least one other device within the wireless network.
Clause 20. The device of clause 18, wherein: the threshold comprises a distance threshold; the threshold is determined based on a position uncertainty of the device at the first location of the device, a network condition, a type of environment of the first location of the device, or a combination thereof; or a combination thereof.

What is claimed is:

1. A method for location determination of a device within a wireless network, the method comprising:
generating, by the device, a first identifier corresponding to a first location of the device, the device being associated with a first identifier corresponding to the first location;
determining, by the device, a change of location of the device relative to the first location of the device;
based on the change of the location of the device exceeding a threshold, generating, by the device, a second identifier associated with the device and corresponding to a second location of the device, the second identifier being distinct from the first identifier;
obtaining, by the device, one or more positioning measurements associated with the second location of the device corresponding to the second identifier; and
sending, to a network entity, the second identifier and the one or more positioning measurements.

2. The method of claim 1, further comprising receiving, from the network entity, a refined location of the device.

3. The method of claim 2, wherein the refined location of the device is based on the obtained one or more positioning measurements and one or more positioning measurements obtained via crowdsourcing from at least one other device within the wireless network.

4. The method of claim 1, wherein the sending of the second identifier and the one or more positioning measurements to the network entity comprises enabling the network entity to associate the one or more positioning measurements with the second identifier without identifying the device in a set of positioning measurements crowdsourced from the device and at least one other device within the wireless network.

5. The method of claim 1, wherein each of the first identifier and the second identifier is based on:
a pseudorandom generation;
an irreversible hashing function of a parameter of the device;
a transient condition that is unrelated to the device or related to the device;
a length that meets or exceeds a threshold; or
a combination thereof.

6. The method of claim 1, wherein:
the threshold comprises a distance threshold;
the threshold is determined based on a position uncertainty of the device at the first location of the device, a network condition, a type of environment of the first location of the device, or a combination thereof; or
a combination thereof.

7. The method of claim 6, wherein the distance threshold is determined based at least on a type of positioning method used by the device to obtain the one or more positioning measurements, a type of signal used by the device to obtain the one or more positioning measurements, or a combination thereof.

8. The method of claim 6, wherein the generating of the second identifier is further based on a time threshold defined by a period of time during which the first identifier is valid.

9. The method of claim 1, further comprising obtaining one or more positioning measurements associated with the first location, and determining the first location of the device based on the one or more positioning measurements associated with the first location.

10. The method of claim 9, further comprising determining the second location based on the one or more positioning measurements associated with the second location;
wherein the determining of the change of location of the device comprises comparing the first location of the device with the second location of the device to determine the change in the location of the device.

11. The method of claim 1, wherein the one or more positioning measurements comprise a signal timing measurement, a signal strength measurement, a signal angle measurement, or a combination thereof.

12. The method of claim 1, wherein the obtaining of the one or more positioning measurements comprises obtaining one or more positioning measurements made using one or more wireless signals via a wireless local area network (WLAN), a cellular protocol, Bluetooth-based protocol, an Ultra Wideband (UWB) protocol, a satellite system, or a combination thereof.

13. The method of claim 1, further comprising:
obtaining one or more positioning measurements associated with the first location; and
determining the change of the location of the device based on the one or more positioning measurements associated with the first location and the one or more positioning measurements associated with the second location of the device.

14. The method of claim 1, wherein the device is associated with the first identifier while the device is at the first location and the change of the location of the device does not exceed the threshold.

15. A device comprising:
one or more transceivers configured for data communication with a network entity;
one or more memory; and
one or more processors communicatively coupled to the one or more transceivers and the one or more memory, the one or more processors configured to:
generate a first identifier corresponding to a first location of the device, the device being associated with a first identifier corresponding to the first location;
determine a change of location of the device relative to the first location of the device;
based on the change of the location of the device exceeding a threshold, generate a second identifier associated with the device and corresponding to a second location of the device, the second identifier being distinct from the first identifier;
obtain one or more positioning measurements associated with the second location of the device corresponding to the second identifier; and
send, to a network entity, the second identifier and the one or more positioning measurements.

16. The device of claim 15, wherein the sending of the second identifier and the one or more positioning measurements to the network entity comprises enabling the network entity to associate the one or more positioning measurements with the second identifier without identifying the device in a set of positioning measurements crowdsourced from the device and at least one other device within the wireless network.

17. The device of claim 15, wherein:
the threshold comprises a distance threshold;
the threshold is determined based on a position uncertainty of the device at the first location of the device, a network condition, a type of environment of the first location of the device, or a combination thereof; or
a combination thereof.

18. A device comprising:
means for generating a first identifier corresponding to a first location of the device, the device being associated with a first identifier corresponding to the first location;
means for determining a change of location of the device relative to the first location of the device;
means for, based on the change of the location of the device exceeding a threshold, generating a second identifier associated with the device and corresponding to a second location of the device, the second identifier being distinct from the first identifier;
means for obtaining one or more positioning measurements associated with the second location of the device corresponding to the second identifier; and
means for sending, to a network entity, the second identifier and the one or more positioning measurements.

19. The device of claim 18, wherein the means for sending of the second identifier and the one or more positioning measurements to the network entity comprises means for enabling the network entity to associate the one or more positioning measurements with the second identifier without identifying the device in a set of positioning measurements crowdsourced from the device and at least one other device within the wireless network.

20. The device of claim 18, wherein:
the threshold comprises a distance threshold;
the threshold is determined based on a position uncertainty of the device at the first location of the device, a network condition, a type of environment of the first location of the device, or a combination thereof; or
a combination thereof.
